(19) United States
(12) Patent Application Publication
(10) Pub. No.: US 2018/0314776 A1
(43) Pub. Date: Nov. 1, 2018

(54) Computer-Implemented Method and System for Modelling Performance of a Fixed-Wing Aerial Vehicle with Six Degrees of Freedom

(71) Applicant: The Boeing Company, Chicago, IL (US)

(72) Inventors: Eduardo Gallo, Madrid (ES); Francisco Navarro, Madrid (ES)

(21) Appl. No.: 15/898,994

(22) Filed: Feb. 19, 2018

(30) Foreign Application Priority Data
Apr. 27, 2017 (EP) 17382226.3

(51) Int. Cl. G06F 17/50; G07C 5/08

(52) U.S. Cl. CPC G06F 17/5009; G07C 5/085

(57) ABSTRACT

Computer-implemented method and system for modelling performance of a fixed-wing aerial vehicle (AV) with six degrees of freedom. The system comprises a collecting unit (330) to collect data from a plurality of modelling measures and modelling maneuvers; a processing unit (340) to communicate with a collecting unit (330). The processing unit (340) further sequentially processes data sets from a plurality of modelling measures and to determine models to generate an accurate APM. Modelling measures and modelling maneuvers are designed to modify an influence on the of variables of a model of the AV (100).

### CROSS REFERENCE TO RELATED APPLICATION

The present application claims priority to EP application number 17382226.3, filed on Apr. 27, 2017, the entire contents of which are herein incorporated by reference.

### FIELD

The present disclosure relates to improvements in aircraft performance models (APMs) used by aircraft trajectory predictors and air traffic simulators in Air Traffic Management (ATM).

### BACKGROUND

An Aircraft Performance Model (APM) is a mathematical representation of the aerodynamic and propulsive forces and moments as well as the fuel consumption produced by an aircraft during flight. According to the degrees of freedom (DOF) there are 3DOF APMs that provide only the aerodynamic and propulsive forces and 6DOF APMs that add the moments around its center of gravity. Although both of them may be valid for trajectory prediction, the former implicitly assume certain simplifications, such as symmetric flight and average control surface positions, and hence result in less accurate results.

Proper APMs should take into account atmospheric conditions, airspeed, aircraft attitude, aircraft mass and its inertia tensor. Advanced trajectory modeling, flight planning, mission control and traffic simulation capabilities rely on APMs. Therefore, it is of great importance to have an accurate APM for recreate aircraft flight and the environment in which an aircraft may fly.

Research, design and development of aircrafts and components may also benefit from high fidelity APMs to ensure an adequate match between the structure (load capability, deformation under stress), the aerodynamic and propulsive loads (forces and moments modeled by the APM), and the aircraft stability, maneuverability, and control. In addition, a very accurate APM has been identified as a potential aid to the aircraft control and navigation systems that can significantly improve their performances. However, generation of an accurate six degrees of freedom (6DOF) APM is an intensive process in terms of time, costs and physical facilities.

Regarding low SWaP (Size, Weight, and Power) aircrafts, it is often beneficial for the manufacturer to avoid or at least simplify on the APM at the expense of a less optimized aircraft overall design and less accurate flight simulation capabilities. Particularly, for the above reasons, there are few suitable APMs for low SWaP Unmanned Air Systems (UAS). Employing generic models is an alternative but results in a significant reduction of accuracy simulation or trajectory prediction activities that poses a significant impediment to be used in civil airspace.

### SUMMARY

In view of the above shortcomings, there is a need for a solution to provide an accurate and cost-efficient APM. The present disclosure aims at a method and a system for modeling performance with six degrees of freedom of a fixed-wing aerial vehicle (AV) capable of reproducing real world effects. In particular, how a fixed-wing AV may respond to certain flight controls or may reacts to external factors.

Generally speaking, the present disclosure concerns steps for performing maneuvers and steps for efficiently collecting data from said maneuvers. Also, there are steps for making appropriate assumptions and calculating APM features. Additionally, there may be steps for confirming whether a certain APM feature is sufficiently well modeled or requires further maneuvers.

A value of this disclosure lays on an improved accuracy and a proper coverage of the flight envelope, which paves the way into enabling advanced control approaches such as model-predictive control (MPC). MPC exploits accurate knowledge of the AV performance to optimally design the control response.

Aside from that value, the APM obtained by using the present teachings may potentially be used not only for high-fidelity simulation and trajectory prediction supporting operational decision making, but also to support the actual trajectory execution (flight control) process.

Another aspect of the present teachings is that they significantly improve accuracy while saving time and costs.

Further objects and advantages of the present invention will be apparent from the following detailed description, reference being made to the accompanying drawings wherein preferred embodiments are clearly illustrated.

### BRIEF DESCRIPTION OF THE DRAWINGS

A series of drawings which aid in better understanding the disclosure and which are presented as non-limiting examples and are very briefly described below.

FIG. 1 illustrates a three-dimensional system used to define the orientation of an aircraft.

FIG. 2 illustrates a flow diagram depicting one embodiment of the disclosed method.

FIG. 3 illustrates a block system according to an embodiment of the disclosed system.

### DETAILED DESCRIPTION

For the purposes of explanation, specific details are set forth in order to provide a thorough understanding of the present disclosure. However, it is apparent to one skilled in the art that the present disclosure may be practiced without these specific details or with equivalent arrangements.

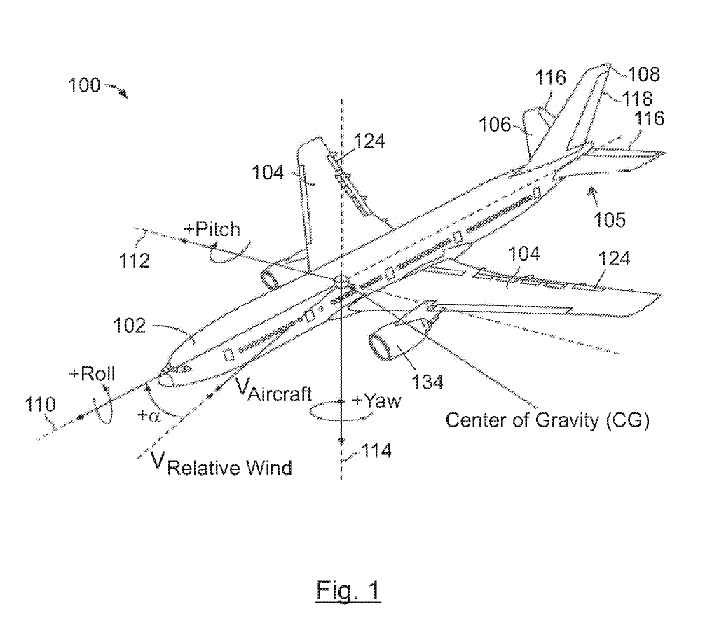

FIG. 1 illustrates the body fixed system (BFS) of a fixed-wing aerial vehicle (AV) 100. A three-dimensional coordinate system is defined through the center of gravity (CoG) with each axis of this coordinate system perpendicular to the other two axes. The AV 100 typically includes a body or fuselage 102, fixed wings 104 that are coupled to the fuselage 102 and a tail 105 that includes a horizontal stabilizer 106 and a vertical stabilizer 108. The AV 100 can rotate about three axes, namely, a longitudinal x-axis 110, a lateral y-axis 112, and a vertical or directional z-axis 114. Roll, pitch and yaw refer to rotations of the AV 100 about the respective axes 110, 112, 114. Pitch refers to the rotation (nose up or down) of the AV 100 about the lateral y-axis 112, roll refers to the rotation of the AV 100 about the longitudinal x-axis 110, and yaw refers to the rotation of the AV 100 about the vertical or directional z-axis 114.

An AV 100 typically include four controls, namely throttle, elevator 116, ailerons 124, and vertical rudder 118. Throttle is used to operate the engines 134 and generate a forward force. Control surfaces: elevator 116, ailerons 124 and vertical rudder 118 allow to aerodynamically control the AV 100 for a stable flight.

Elevator 116 is used to raise or lower the nose of the AV 100. Ailerons 124 are located on the outside of the wings 104 and are used to rotate AV 100. The ailerons 124 move anti-symmetrically (i.e. one goes up, the one on the opposite side low). Vertical rudder 118 is used so that the aircraft does not skid.

It is assumed that the AV 100 is equipped with an aircraft flight control system. The AV 100 may be commanded with the flight control system to automatically perform certain maneuvers and collect data (via telemetry) in real time that serve to generate an APM. At least some of these tasks may be coded in a computer program. Some of these computer program instructions, when running, may steer the AV 100 to perform modelling maneuvers. Said maneuvers advantageously provide data that can be collected and used to generate APM features in a sequence of different steps to arrive at an accurate APM that reproduces the behavior of the AV 100.

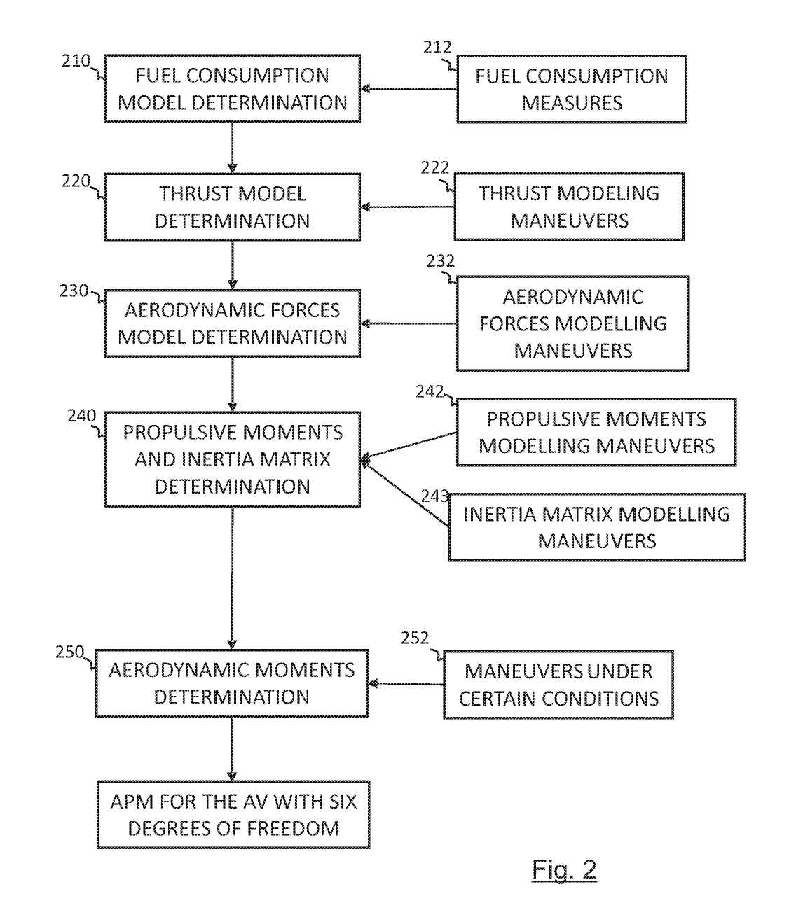

FIG. 2 illustrates several steps of an embodiment according to the present disclosure to generate an APM for a particular fixed-wings AV. Generally, the model determined in a step serves for determining another model in a subsequent step.

A first step of fuel consumption model determination 210 is based on fuel consumption measures 212 performed under different conditions of air density, outside air temperature (OAT) and throttle level (ET).

A second step of thrust model determination 220 is based on thrust modeling maneuvers 222 performed under conditions of coordinated flight (a flight without sideslip), constant barometric altitude for a plurality of AV mass variations, a plurality throttle levels and a plurality of angle of attack (AOA) values for different air densities, OAT and throttle levels.

A third step of aerodynamic forces model determination 230 is based on data collected from aerodynamic forces modelling maneuvers 232 like AOA-on-elevator, AOS-on-rudder (angle of sideslip) and speed-on-elevator.

A fourth step of propulsive moments and inertia matrix determination 240 is based on data collected from propulsive moments modelling maneuvers 242 from control loops of AOS-on-rudder and bank-on-ailerons. Optionally, maneuvers 242 may be performed under conditions of coordinated flight or actuating the elevator.

Inertia matrix moments modelling maneuvers 243 may be performed under conditions of lateral perturbation via rudder actuation for several AV mass variations.

A fifth step of aerodynamic moments determination 250 is based on data collected from performing maneuvers under certain conditions 252 like AOS-on-rudder, bank-on-ailerons and q-on-elevator.

Once this sequence of steps is performed for the considered fixed-wings AV, its corresponding APM can be obtained.

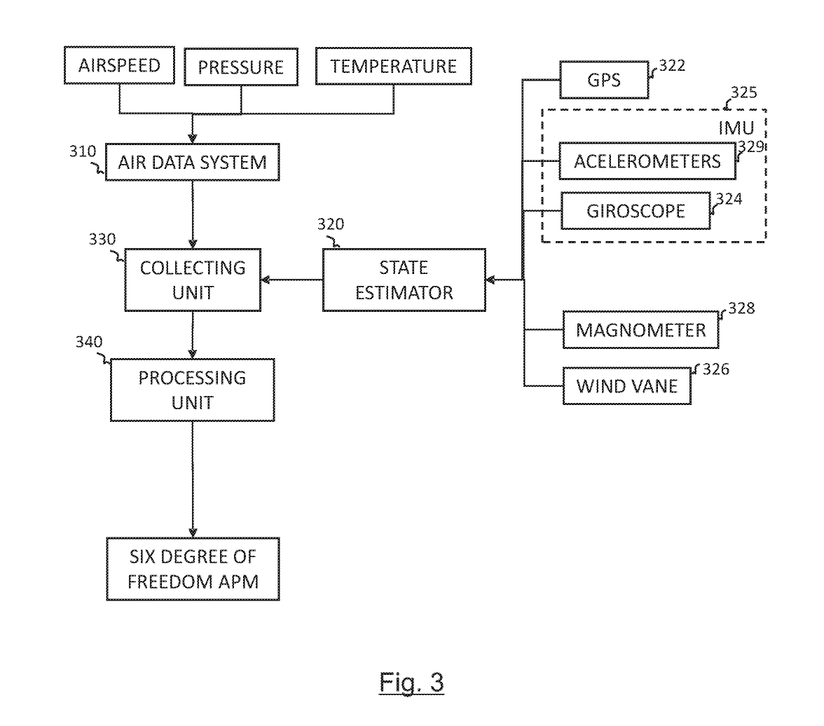

FIG. 3 shows an embodiment of a system to generate an APM according to the present disclosure. As to instrumentation and data acquisition, the AV 100 is assumed to be equipped with a state estimator 320 an air data system 310. The state estimator 320 may fusion GPS 322, IMU 325 (e.g. solid-state accelerometers 329 and gyros 324), magnetometer 328, wind vanes 326 (providing direct observation of angle-of-attack and angle-of-sideslip). The air data system 310 provides observations of true airspeed, pressure and temperature to produce an estimate (e.g. in the sense of the Extended Kalman Filter).

The aircraft flight control system of the AV 100 includes a processing unit 340 that may instruct operating mechanisms that actuate control surfaces to modify direction in flight. The processing unit 340 also may manage throttle that controls engines to modify speed.

Several actions can be performed as outlined in FIG. 2, including flight modelling maneuvers 222, 232, 242, 243 and 252 and associated measures for collecting data in order to sequentially build an APM for the AV 100. At least some of them may be automated and implemented in flight via processing unit 340 to reduce complexity and facilitate computations to generate a realistic APM. Main maneuvers of assistance to generate the APM are:
AOS-on-rudder
Altitude-on-bank
Speed-on-elevator
AOA-on-elevator
Pitch rate-on-elevator

These will be evidenced in the following example expressed with a more detailed mathematical formulation.

### Formal Example of APM Identification

The present example mathematically demonstrates how a series of modelling maneuvers and measures under particular conditions are used to generate data to be collected in order to determine parameters of each particular model by means of least squares (LS).

### Position (WGS84):

{λ, φ, h} Geodetic coordinates
Linear speed (LLS):
u Absolute horizontal speed
χ True bearing
w Absolute vertical speed
v Module of the absolute speed
γ Absolute (geometric) path angle
μ Absolute bank angle
u_{TAS} Horizontal component of the true airspeed
χ_{TAS} Bearing of the true airspeed
w_{TAS} Vertical component of the true airspeed
v_{TAS} Module of the true airspeed v_{TAS}=\sqrt{u_{TAS}²+w_{TAS}²}
γ_{TAS} Aerodynamic path angle
μ_{TAS} Aerodynamic bank angle
u_{WIND} Horizontal component of the wind speed
χ_{WIND} Bearing of the wind speed
w_{WIND} Vertical component of the wind speed
v_{WIND} Module of the wind speed v_{WIND}=\sqrt{u_{WIND}²+w_{WIND}²}
Linear acceleration (BFS):

$$[ \begin{matrix}{a}_{1}^{BFS} \\ {a}_{2}^{BFS} \\ {a}_{3}^{BFS}\end{matrix} ]$$

BFS components of the non-gravitational accelerations (likewise sensed by a 3-axis accelerometer)

### Attitude (BFS):

{ξ,ϑ,ψ} Euler angles
α Angle-of-attach (AOA)
β Angle-of-sideslip (AOS)
Angular speed (BFS):

$$[ \begin{matrix}p \\ q \\ r\end{matrix} ]$$

BFS components of the angular speed of the AV with respect to LLS

$$[ \begin{matrix}\dot{α} \\ \dot{β}\end{matrix} ]$$

### Derivatives of AOA and AOS

Angular acceleration (BFS): [angular acceleration not typically a native observable in low-cost IMUs, which implies numerical derivation]

$$[ \begin{matrix}\dot{p} \\ \dot{q} \\ \dot{r}\end{matrix} ]$$

BFS components of the angular acceleration of the AV with respect to LLS

The accelerometer measures {a₁^{BFS}, a₂^{BFS}, a₃^{BFS}} provide the means to split the 3 equations that govern the linear dynamics (i.e. the motion of the AV's gravity center) in two systems where either non-gravitational only forces (i.e. aerodynamic and propulsive) or gravitational-only forces (i.e. weight and Coriolis inertia force) appear. The first system, represented by expression [1] (with further details in expression [2]) is the one off interest to our purpose:

$$\begin{matrix}[ \begin{matrix}{Tt}_{1} - D \\ {Tt}_{2} - Q \\ {Tt}_{3} - L\end{matrix} ] = m [ \begin{matrix}{a}_{1}^{BFS} cos α cos β + {a}_{2}^{BFS} sin β + {a}_{3}^{BFS} sin α cos β \\ - {a}_{1}^{BFS} cos α sin β + {a}_{2}^{BFS} cos β - {a}_{3}^{BFS} sin α sin β \\ - {a}_{1}^{BFS} sin α + {a}_{3}^{BFS} cos α\end{matrix} ] & [ 1 ] \\ {t}_{1} ( α , β , υ , ɛ ) = cos α cos β cos υ cos ɛ - sin β sin υ cos ɛ - sin α cos β sin ɛ \\ {t}_{2} ( α , β , υ , ɛ ) = - ( cos α sin β cos υ cos ɛ + cos β sin υ cos ɛ - sin α cos β sin ɛ ) \\ {t}_{3} ( α , υ , ɛ ) = - ( sin α cos υ cos ɛ + cos α sin ɛ ) & [ 2 ]\end{matrix}$$

The variables that take part of expression [1] can be classified as follows:
a₁^{BFS}, a₂^{BFS}, a₃^{BFS}, α, β are observable aspects of the AV state at any time, provided by the estate estimator
υ, ε define the direction of the thrust force with respect to BFS; they are unknowns, in principle, but small constant angles (i.e., v<<1 and E<<1)
m (the actual mass) is a slowly varying variable
L, Q, D, T respectively represent the aerodynamic lift, side and drag forces and the thrust force

In the quasi-steady state assumption (\dot{α}≅\dot{β}≅0), aerodynamic and propulsive forces can be expressed as:

$$\begin{matrix}L = \frac{1}{2} κ {p}_{0} δ {M}^{2} {SC}_{L} ( α , β , M , \hat{p} , \hat{q} , \hat{r} , {ɛ}_{h} , {ɛ}_{a} , {ɛ}_{r} , {ɛ}_{e} ) & [ 3 ] \\ Q = \frac{1}{2} κ {p}_{0} δ {M}^{2} {SC}_{Q} ( α , β , M , \hat{p} , \hat{q} , \hat{r} , {ɛ}_{h} , {ɛ}_{a} , {ɛ}_{r} , {ɛ}_{e} ) & [ 4 ] \\ D = \frac{1}{2} κ {p}_{0} δ {M}^{2} {SC}_{Q} ( α , β , M , \hat{p} , \hat{q} , \hat{r} , {ɛ}_{h} , {ɛ}_{a} , {ɛ}_{r} , {ɛ}_{e} ) & [ 5 ] \\ T = {W}_{MTOW} {δC}_{T} ( δ , θ , M , {ɛ}_{T} ) & [ 6 ] \\ \hat{p} = \frac{{pb}_{w}}{2 {v}_{TAS}} {b}_{w} is the wingspan & [ 7 ] \\ \hat{q} = \frac{{qc}_{w}}{2 {v}_{TAS}} {c}_{w} is the wing mean aerodynamic chord & [ 8 ] \\ \hat{r} = \frac{{rb}_{w}}{2 {v}_{TAS}} & [ 9 ]\end{matrix}$$

With typical symmetry assumptions:

L=½κp₀δM²SC_{L}(α,β,M,\hat{q},εₕ,εₑ) [10]

Q=½κp₀δM²SC_{Q}(α,β,M,\hat{p},\hat{r},εₐ,εᵣ) [11]

D=½κp₀δM²SC_{D}(α,β,M,\hat{q},εₕ,εₑ) [12]

### Step 210 for Determination of a Fuel Consumption Model

The APM identification process starts with fuel consumption modelling measures 212 as a bench test intended to identify instantaneous fuel consumption as a function of air density, temperature and throttle level:

$$\begin{matrix}\dot{m} = - F & [ 13 ] \\ m = {m}_{0} - {\int }_{{t}_{0}}^{t} Fdt & [ 14 ] \\ F = \frac{{w}_{MTOW} {a}_{0} δ \sqrt{θ}}{{L}_{HV}} {C}_{F} ( δ , θ , {ɛ}_{T} ) & [ 15 ]\end{matrix}$$

In effect, C_{F}(δ,θ,ε_{T}) can be identified for the air pressure δ and temperature θ conditions existing at the moment of conducting the bench test, which shall measure mass variation at different levels of ε_{T} within its range [0,1], fixed during a time interval wide enough to accurately measure fuel consumption. Alternatively (or complementarily) a direct measure of F can be obtained through a precise caudalimeter. Ideally, the bench tests should be repeated for significantly different temperature and pressure conditions in order to capture its dependence with such variables.

Once the fuel consumption model C_{F}(δ,θ,ε_{T}) is identified, expression [14] allows the calculation of the instantaneous mass at any time, as a function of the variation of δ, θ and ε_{T} recorded over the time elapsed from the initial time t₀ where the initial mass was m₀.

### Step 220 for Determination of a Thrust Model

Lateral aerodynamic force Q is symmetric with respect to its dependency with AOS or, in other words, Q is null for coordinated flight, i.e.:

β≡0⇒Q≡0 [16]

Thus, if a basic control loop AOS-on-rudder is implemented to maintain coordinated flight for any value of εₐ, expression [1] turns into the much simpler form:

$$[ \begin{matrix}{Tt}_{1} - \frac{1}{2} κ {p}_{0} δ {M}^{2} {SC}_{D} \\ {Tt}_{2} \\ {Tt}_{3} - \frac{1}{2} κ {p}_{0} δ {M}^{2} {SC}_{L}\end{matrix} ] = m [ \begin{matrix}{a}_{1}^{BFS} cos α + {a}_{3}^{BFS} sin α \\ {a}_{2}^{BFS} \\ - {a}_{1}^{BFS} sin α + {a}_{3}^{BFS} cos α\end{matrix} ] \qquad [ 17 ]$$

For AVs that fly at moderate speeds, i.e. at Mach numbers that allow neglecting compressibility effects, the dependency of C_{L}, C_{Q} and C_{D} with the Mach number M can be neglected. Furthermore, for coordinated flights (null AOS), linear aerodynamics theory shows that at moderate AOA, C_{D} depends quadratically with the AOA while C_{L} depends linearly with the AOA, which enables relating both coefficients through the classical parabolic drag polar (first order approach):

C_{D}=C_{D,0}+C_{D,2}C_{L}² [18]

Such model can be extended to cope with compressibility effects to certain extent by tailoring the coefficients to a given Mach. Thus, for coordinated level flight at given Mach M and trim condition εₕ:

C_{D}(α,0,M,0,εₕ,0)=C_{D,0}+Kα² [19]

C_{L}(α,0,M,0,εₕ,0)=C_{L,1}α [20]

K(α,0,M,0,εₕ,0)=C_{D,2}C_{L,1}² [21]

with C_{D,0}, K, C_{L,1} and C_{D,2} depending on the selected speed M and trim condition εₕ

$$\begin{matrix}[ \begin{matrix}T ( cos α cos υ cos ɛ - sin α sin ɛ ) - \frac{1}{2} κ {p}_{0} δ {M}^{2} S ( {C}_{D , 0} + K {α}^{2} ) \\ - T sin υ cos ɛ \\ - T ( sin α cos υ cos ɛ + cos α sin ɛ ) - \frac{1}{2} κ {p}_{0} δ {M}^{2} {SC}_{L , 1} α\end{matrix} ] = m [ \begin{matrix}{a}_{1}^{BFS} cos α + {a}_{3}^{BFS} sin α \\ {a}_{2}^{BFS} \\ - {a}_{1}^{BFS} sin α + {a}_{3}^{BFS} cos α\end{matrix} ] & [ 22 ] \\ [ \begin{matrix}T ( cos υ cos ɛ cos α - T sin ɛ sin α ) - \frac{1}{2} κ {p}_{0} δ {M}^{2} S ( {C}_{D , 0} + K {α}^{2} ) \\ - T sin υ cos ɛ \\ - T cos υ cos ɛ sin α - T sin ɛ cos α - \frac{1}{2} κ {p}_{0} δ {M}^{2} {SC}_{L , 1} α\end{matrix} ] = m [ \begin{matrix}{a}_{1}^{BFS} cos α + {a}_{3}^{BFS} sin α \\ {a}_{2}^{BFS} \\ - {a}_{1}^{BFS} sin α + {a}_{3}^{BFS} cos α\end{matrix} ] & [ 23 ] \\ [ \begin{matrix}{W}_{MTOW} δ cos α & - {W}_{MTOW} δ sin α & 0 & - \frac{1}{2} κ {p}_{0} δ {M}^{2} S & 0 & - \frac{1}{2} κ {p}_{0} δ {M}^{2} S {α}^{2} \\ 0 & 0 & - {W}_{MTOW} δ & 0 & 0 & 0 \\ - {W}_{MTOW} δ sin α & - {W}_{MTOW} δ cos α & 0 & 0 & - \frac{1}{2} κ {p}_{0} δ {M}^{2} S α & 0\end{matrix} ] [ \begin{matrix}a \\ b \\ c \\ {C}_{D , 0} \\ {C}_{L , 1} \\ K\end{matrix} ] = m [ \begin{matrix}{a}_{1}^{BFS} cos α + {a}_{3}^{BFS} sin α \\ {a}_{2}^{BFS} \\ - {a}_{1}^{BFS} sin α + {a}_{3}^{BFS} cos α\end{matrix} ] & [ 24 ]\end{matrix}$$

where:

a=C_{T} cos υ cos ε

b=C_{T} sin ε

c=C_{T} sin υ cos ε [25]

The linear observation problem represented by expression [24] is underdetermined, as there are only 3 equations for 6 unknowns. Furthermore, while C_{D,0}, C_{L,1} and K depend on the Mach number M and trim condition εₕ, the unknowns a, b and c depend on the same variables as C_{T}, i.e. {δ,θ,M,ε_{T}}. The thrust model determination step 220 may be performed through flight testing when the flight is controlled so the mentioned variables are held constant, which can be achieved by performing thrust modelling maneuvers 222:
δ and θ can be held almost constant by holding barometric altitude H through an altitude-on-bank control loop (as pressure varies relatively slowly with altitude, it is reserved the elevator to control speed through AOA); both positive and negative banks should be used to prevent asymmetry issues. Holding barometric altitude makes \dot{α}≅\dot{β}≅q≅0.
The throttle level ε_{T} is held constant
For the selected throttle level, M is held constant through a speed-on-elevator control loop; the value of M is chosen so that level flight requires adopting a bank angle that leaves the altitude-on-bank loop room for altitude control through slightly increasing or decreasing bank angle as needed

Given the actual mass m there is a unique pair of values of a and trim condition εₕ that make the flight condition described possible. Thus, in order to render the linear observation system of [24] determined or, preferably, overdetermined, k>2 different samples of AOA (ranging from low to high, but avoiding stall) and corresponding actual mass need to be considered, which add more observation equations without adding more unknowns. The idea is to perform a sequence of cases (ideally within the same flight test to avoid variations in the relationship between δ and θ), for different values of {δ, θ, M, ε_{T}}, which shall be repeated several times once the mass has experienced a significant change due to fuel consumption so the dataset collected ends up containing enough samples (i=1, . . . , k) of the same cases (j=1, . . . , l) for significantly different actual masses (and, thus, AOA values). In order to capture the variation of C_{T} with δ and θ independently, the tasks should be repeated under different OAT (Outside Air Temperature) conditions with sufficient variation among each other covering the desired operational range (e.g. early in the morning vs. noon or selecting cold vs. hot days).

$${H}_{ij} = [ \begin{matrix}{W}_{MTOW} {δ}_{j} cos {α}_{i} & - {W}_{MTOW} {δ}_{j} cos {α}_{i} & 0 & - \frac{1}{2} κ {p}_{0} {δ}_{j} {M}_{j}^{2} S & 0 & - \frac{1}{2} κ {p}_{0} {δ}_{j} {M}_{j}^{2} S {α}_{i}^{2} \\ 0 & 0 & - {W}_{MTOW} {δ}_{j} & 0 & 0 & 0 \\ - {W}_{MTOW} {δ}_{j} sin {α}_{i} & - {W}_{MTOW} {δ }_{j} cos {α}_{i} & 0 & 0 & - \frac{1}{2} κ {p}_{0} {δ}_{j} {M}_{j}^{2} S {α}_{i} & 0\end{matrix} ] \qquad [ 26 ]$$

Observation Matrix for Sample i of Case j

$${z}_{j} = [ \begin{matrix}{a}_{j} \\ {b}_{j} \\ {c}_{j} \\ {C}_{D , 0 , j} \\ {C}_{L , 1 , j} \\ {K}_{j}\end{matrix} ]$$

Vector of Unknowns for Case j

$${O}_{ij} = {m}_{i} [ \begin{matrix}{a}_{1 , ij}^{BFS} cos {α}_{i} + {a}_{3 , ij}^{BFS} sin {α}_{i} \\ {a}_{1 , ij}^{BFS} \\ - {a}_{1 , ij}^{BFS} sin {α}_{i} + {a}_{3 , ij}^{BFS} cos {α}_{i}\end{matrix} ]$$

Vector of Observations for Sample i of Case j

By combining all samples (for i=1, . . . , k) of case j, the overdetermined linear observation system below is obtained:

$$\begin{matrix}{H}_{ij} = f ( {δ}_{j} , {θ}_{j} , {M}_{j} , {α}_{i} ) & [ 29 ] \\ {O}_{ij} = f ( {m}_{i} , {α}_{i} , {a}_{1 , ij}^{BFS} , {a}_{1 , ij}^{BFS} , {a}_{3 , ij}^{BFS} ) & [ 30 ] \\ {H}_{j} = [ \begin{matrix}{H}_{1 j} \\ {H}_{2 j} \\ ⋮ \\ {H}_{kj}\end{matrix} ] & [ 31 ] \\ {O}_{j} = [ \begin{matrix}{O}_{1 j} \\ {O}_{2 j} \\ ⋮ \\ {O}_{kj}\end{matrix} ] & [ 32 ] \\ {H}_{j} {z}_{j} = {O}_{j} & [ 33 ]\end{matrix}$$

The best estimation of zⱼ in the least-squares sense is given by the expression:

z₁=(Hⱼ^{T}Hⱼ)⁻¹Hⱼ^{T}Oⱼ for j=1, . . . ,l [34]

The LS solution obtained also provides a model of the aerodynamic drag and lift coefficients as a function of AOA and Mach valid for null AOS conditions.

To identify ε and υ (constant for all the cases) and C_{T}(δ, θ, M, ε_{T}) for each particular case further processing is required. In effect, expression [25] can then be used to obtain a linear observation system from [25], assuming that ε and υ are very small angles, the following approximation may be made:

a=C_{T}

b=C_{T}ε

C=C_{T}υ [35]

and take logarithms in both sides of the equations:

ln a=ln C_{T}

ln b=ln C_{T}+ln ε

ln c=ln C_{T}+ln υ [36]

Considering all the cases identified above, an overall linear observation system for ε and υ and C_{T,j} for j=1, . . . , l can be composed as follows:

$$\begin{matrix}H = [ \begin{matrix}0 & 0 & 1 & 0 & … & 0 \\ 1 & 0 & 1 & 0 & … & 0 \\ 0 & 1 & 1 & 0 & … & 0 \\ 0 & 0 & 0 & 1 & … & 0 \\ 1 & 0 & 0 & 1 & … & 0 \\ 0 & 1 & 0 & 1 & … & 0 \\ ⋮ & ⋮ & ⋮ & ⋮ & & ⋮ \\ 0 & 0 & 0 & 0 & … & 1 \\ 1 & 0 & 0 & 0 & … & 1 \\ 0 & 1 & 0 & 0 & … & 1\end{matrix} ] dim ( H ) = 3 l \times ( 2 + l ) & [ 37 ] \\ O = [ \begin{matrix}ln {a}_{1} \\ ln {b}_{1} \\ ln {c}_{1} \\ ln {a}_{2} \\ ln {b}_{2} \\ ln {c}_{2} \\ ⋮ \\ ln {a}_{l} \\ ln {b}_{l} \\ ln {c}_{l}\end{matrix} ] dim ( O ) = 3 l \times ( 2 + l ) & [ 38 ] \\ z = [ \begin{matrix}ln ɛ \\ ln υ \\ ln {C}_{T , 1} \\ ln {C}_{T , 2} \\ ⋮ \\ ln {C}_{T , l}\end{matrix} ] dim ( z ) = ( 2 + l ) \times 1 & [ 39 ]\end{matrix}$$

The LS solution is then obtained as:

z=(H^{T}H)⁻¹H^{T}O [40]

which finally renders:

$$ɛ = exp ( z [ 1 ] )$$

$$υ = exp ( z [ 2 ] )$$

$$Thrust orientation parameters$$

$$\begin{matrix}{C}_{T , 1} = {C}_{T} ( {δ}_{1} , {θ}_{1} , {M}_{1} , {ɛ}_{T , 1} ) = exp ( z [ 2 + 1 ] ) \\ {C}_{T , 2} = {C}_{T} ( {δ}_{2} , {θ}_{2} , {M}_{2} , {ɛ}_{T , 2} ) = exp ( z [ 2 + 2 ] ) \\ … \\ {C}_{T , l} = {C}_{T} ( {δ}_{l} , {θ}_{l} , {M}_{l} , {ɛ}_{T , l} ) = exp ( z [ 2 + l ] )\end{matrix}$$

$$Thrust coefficients identified for all the test cases performed$$

The thrust model determination step 220 described above has a limitation associated to the fact that all these test cases are performed at constant altitudes. In the experimental conditions defined, the thrust model derived cannot capture thrust levels below the minimum required to hold altitude in level flight with minimum actual mass at the speed that renders maximum aerodynamic efficiency (i.e. the minimum thrust to sustain level flight with minimum mass). Thus, no thrust information can be obtained for throttle levels that deliver a thrust lower than that one, for which it is needed an alternative approach that involves lower throttle levels.

A possible approach to identify the low throttle part of the thrust model may consist on performing decelerations at constant altitude to avoid variations of δ and θ. Starting from a flight condition at high speed (M) and high bank angle should give enough time to record speed variations in between the time when the engine transient (after having set and held a low throttle level) is over and the moment where level flight can no longer be sustained. Another approach may consist on performing descents holding low throttle level and, e.g speed (M), and record data at the altitudes of interest. In both cases, the thrust can be estimated through the following expression:

$${W}_{MTOW} δ [ \begin{matrix}cos α cos υ cos ɛ - sin α sin ɛ \\ - sin υ cos ɛ \\ - ( sin α cos υ cos ɛ + cos α sin ɛ )\end{matrix} ] {C}_{T} = m [ \begin{matrix}{a}_{1}^{BFS} cos α + {a}_{3}^{BFS} sin α \\ {a}_{2}^{BFS} \\ - {a}_{1}^{BFS} sin α + {a}_{3}^{BFS} cos α\end{matrix} ] + \frac{1}{2} κ {p}_{0} δ {M}^{2} S [ \begin{matrix}( {C}_{D , 0} + {K}_{{α}^{2}} ) \\ 0 \\ {C}_{L , 1} α\end{matrix} ]$$

with ε, υ, C_{D,0}, K and C_{L,1} already known, which already makes expression [43] an overdetermined linear observation system for C_{T}. In principle, no special provisions and or control for δ, α, m or M are required as all these variables are observables, however, for practical reasons, it might be of interest to set up/control then and/or record data to fit the same cases identified for higher throttle levels.

In effect, to identify C_{T}(δⱼ,θⱼ,Mⱼ,ε_{T,j}) following the first approach, δⱼ and be set and held for the same cases as in high throttle and C_{T} estimated when M matches the Mach Mⱼ associated to those cases. If the second approach is followed, Mⱼ can be set and held and then estimate C_{T} when δⱼ matches the cases identified for high throttle levels. The dependency of thrust with θ is less than an issue for low level throttle. Notice that regardless the approach, this identification problem does only require controlling 2 control DOFs of the AV motion, namely, the throttle level and either altitude (in the first approach) or Mach (in the second approach), which allows using the remaining 3^{rd} DOF to change AOA or bank angle to increase redundancy in the observation and, thus, achieve more robust estimations of C_{T}. Alternatively, redundancy of observations in this problem can be, again, increased by repeating the test cases for different masses and corresponding AOAs, analogously to what has been done in the high throttle cases.

Expression [43] can be employed in general to further identify thrust model cases or refine them regardless the level of throttle, once ε, υ, C_{D,0}, K and C_{L,1} are well known, as long as AOS is held null.

### Step 230 for Determination of Aerodynamic Forces Model

Once the thrust model parameters have been identified, expression [1] can be used again, this time as a direct observer for the aerodynamic force coefficients as follows:

$$\frac{1}{2} κ {p}_{0} δ {M}^{2} S [ \begin{matrix}{C}_{D} \\ {C}_{Q} \\ {C}_{L}\end{matrix} ] = [ \begin{matrix}{Tt}_{1} \\ {Tt}_{2} \\ {Tt}_{3}\end{matrix} ] - m [ \begin{matrix}{a}_{1}^{BFS} cos α cos β + {a}_{2}^{BFS} sin β + {a}_{3}^{BFS} sin αcos β \\ - {a}_{1}^{BFS} cos α sin β + {a}_{2}^{BFS} cos β - {a}_{3}^{BFS} sin αsin β \\ - {a}_{1}^{BFS} sin α + {a}_{3}^{BFS} cos α\end{matrix} ]$$

with T given by expression [6], where the thrust model C_{T}(δ,θ,M,ε_{T}) is already known from previous step.

Expression [44] allows the direct estimation of the aerodynamic force coefficients C_{D}, C_{Q} and C_{L} in terms of their dependency variables through flight testing, for which the respective domains have to be swept, which can be done manually and or with the help of control loops such as AOA-on-elevator and AOS-on-rudder and speed-on-elevator. If the mentioned control loops are available, an alternative approach to the identification of the aerodynamic force coefficients could take advantage of the two remaining control degrees of freedom (i.e. ailerons and throttle) and variables such as δ, M and θ to produce an overdetermined linear observation system, which would, expectedly, bring a best estimate where errors are further compensated.

Another validation that can be done is to check how well C_{D} and C_{L} fit the parabolic drag polar coefficients as a function of Mach identified in Step 220 for the case of null AOS.

Once the thrust model is known, expression [44] can still be used, if necessary, to estimate aerodynamic coefficients in the most general form:

C_{L}=C_{L}(α,M,\dot{\hat{α}},\dot{\hat{β}},\hat{p},\hat{q},\hat{r},εₕ,εₐ,εᵣ,εₑ) [45]

C_{Q}=C_{Q}(α,M,\dot{\hat{α}},\dot{\hat{β}},\hat{p},\hat{q},\hat{r},εₕ,εₐ,εᵣ,εₑ) [46]

C_{D}=C_{D}(α,M,\dot{\hat{α}},\dot{\hat{β}},\hat{p},\hat{q},\hat{r},εₕ,εₐ,εᵣ,εₑ) [47]

where:

$$\hat{\dot{α}} = \frac{\dot{α} {c}_{w}}{2 {v}_{TAS}}$$

$$\hat{\dot{β}} = \frac{\dot{β} {b}_{w}}{2 {v}_{TAS}}$$

However, for uncompressible aerodynamics and small AOS the main dependencies of the aerodynamics coefficients under the quasi-steady state and typical symmetry assumptions get simpler:

C_{L}=C_{L}(α,\hat{q},εₕ,εₑ) [50]

C_{Q}=C_{Q}(β,\hat{p},\hat{r},εₐ,εᵣ) [51]

C_{D}=C_{D}(α,\hat{q},εh,εₑ) [52]

### Step 240 for Determination of Inertia Properties and Propulsive Moments

The 2^{nd} Newton law applied to angular dynamics renders the following expression for the balance of moments:

$$[ \begin{matrix}{R}_{A} \\ {P}_{A} \\ {Y}_{A}\end{matrix} ] = [ \begin{matrix}{I}_{xx} & 0 & - {I}_{xz} \\ 0 & {I}_{yy} & 0 \\ - {I}_{xz} & 0 & {I}_{zz}\end{matrix} ] [ \begin{matrix}\dot{p} - {D}_{9} pq + {D}_{10} qr \\ \dot{q} + {D}_{11} ( {p}^{2} - {r}^{2} ) + {D}_{12} pr \\ \dot{r} - {D}_{13} pq + {D}_{14} qr\end{matrix} ] - T [ \begin{matrix}{E}_{1} \\ {E}_{2} \\ {E}_{3}\end{matrix} ] - {M}_{T} [ \begin{matrix}cos υ cos ɛ \\ - sin υ cos ɛ \\ - sin ɛ\end{matrix} ]$$

### Where:

$${D}_{9} = {D}_{7} {I}_{xz} - {D}_{3} {D}_{8}$$

$${D}_{10} = {D}_{1} {D}_{7} + {D}_{8} {I}_{xz}$$

$${D}_{11} = {D}_{6} {I}_{xz}$$

$${D}_{12} = {D}_{2} {D}_{6}$$

$${D}_{13} = {D}_{8} {I}_{xz} - {D}_{3} {D}_{5}$$

$${D}_{14} = {D}_{1} {D}_{8} + {D}_{5} {I}_{xz}$$

$${D}_{1} = {I}_{zz} - {I}_{yy}$$

$${D}_{2} = {I}_{xx} - {I}_{zz}$$

$${D}_{3} = {I}_{yy} - {I}_{xx}$$

$${D}_{4} = \frac{{I}_{xx} {I}_{zz} - {I}_{xz}^{2}}{{I}_{yy}}$$

$${D}_{5} = \frac{{I}_{xx}}{{I}_{yy} {D}_{4}} = \frac{{I}_{xx}}{{I}_{xx} {I}_{zz} - {I}_{xz}^{2}}$$

$${D}_{6} = \frac{1}{{I}_{yy}}$$

$${D}_{7} = \frac{{I}_{zz}}{{I}_{yy} {D}_{4}} = \frac{{I}_{zz}}{{I}_{xx} {I}_{zz} - {I}_{xz}^{2}}$$

$${D}_{8} = \frac{{I}_{xz}}{{I}_{yy} {D}_{4}} = \frac{{I}_{xz}}{{I}_{xx} {I}_{zz} - {I}_{xz}^{2}}$$

$${I}_{xx} , {I}_{yy} , {I}_{zz} , {I}_{xz} = f ( m )$$

$${E}_{1} = - {y}_{{O}_{T}}^{BFS} sin ɛ + {z}_{{O}_{T}}^{BFS} sin υ cos ɛ$$

$${E}_{2} = {x}_{{O}_{T}}^{BFS} sin ɛ + {z}_{{O}_{T}}^{BFS} cos υ cos ɛ$$

$${E}_{3} = - {x}_{{O}_{T}}^{BFS} sin υ cos ɛ - {y}_{{O}_{T}}^{BFS} cos υ cos ɛ \\ [ \begin{matrix}{R}_{T} \\ {P}_{T} \\ {Y}_{T}\end{matrix} ] = T [ \begin{matrix}{E}_{1} \\ {E}_{2} \\ {E}_{3}\end{matrix} ] + {M}_{T} [ \begin{matrix}cos υ cos ɛ \\ - sin υ cos ɛ \\ - sin ɛ\end{matrix} ]$$

Propulsive or thrust-related moments

In the general case, aerodynamic moments can be expressed as:

R_{A}=½κp₀δM²Sb_{w}C_{R}(α,β,M,\dot{\hat{α}},\dot{\hat{β}},εₕ,εₐ,εᵣ,εₑ) Aerodynamic roll moment [61]

P_{A}=½κp₀δM²Sb_{w}C_{P}(α,β,M,\dot{\hat{α}},\dot{\hat{β}},εₕ,εₐ,εᵣ,εₑ) Aerodynamic pitch moment [62]

Y_{A}=½κp₀δM²Sb_{w}C_{Y}(α,β,M,\dot{\hat{α}},\dot{\hat{β}},εₕ,εₐ,εᵣ,εₑ) Aerodynamic yaw moment [61]

M_{T}=m_{MTOW}b_{w}²Nₛ²C_{M}_{_{T}} Reactive torque due to rotating engine parts & propeller, where the rotating speed Nₛ is assumed to be observable [64]

With the assumption that ε and υ are small angles:

$${M}_{T} [ \begin{matrix}1 \\ - υ \\ - ɛ\end{matrix} ]$$

$${E}_{1} = - {y}_{{O}_{T}}^{BFS} ɛ + {z}_{{O}_{T}}^{BFS} υ$$

$${E}_{2} = {x}_{{O}_{T}}^{BFS} ɛ + {z}_{{O}_{T}}^{BFS}$$

$${E}_{3} = - {x}_{{O}_{T}}^{BFS} υ - {y}_{{O}_{T}}^{BFS} \\ [ \begin{matrix}{R}_{A} \\ {P}_{A} \\ {Y}_{A}\end{matrix} ] = [ \begin{matrix}{I}_{xx} & 0 & - {I}_{xz} \\ 0 & {I}_{yy} & 0 \\ - {I}_{xz} & 0 & {I}_{zz}\end{matrix} ] [ \begin{matrix}\dot{p} - {D}_{9} pq + {D}_{10} qr \\ \dot{q} + {D}_{11} ( {p}^{2} - {r}^{2} ) + {D}_{12} pr \\ \dot{r} - {D}_{13} pq + {D}_{14} qr\end{matrix} ] - T [ \begin{matrix}{E}_{1} \\ {E}_{2} \\ {E}_{3}\end{matrix} ] - {M}_{T} [ \begin{matrix}1 \\ - υ \\ - ɛ\end{matrix} ]$$

$$\frac{1}{2} κ {p}_{0} δ {M}^{2} {Sb}_{w} {C}_{R} ( α , β , M , \hat{\dot{α}} , \hat{\dot{β}} , \hat{p} , \hat{q} , \hat{r} , {ɛ}_{h} , {ɛ}_{a} , {ɛ}_{r} , {ɛ}_{e} ) = {I}_{xx} ( m ) ( \dot{p} - {D}_{9} pq + {D}_{10} qr ) - {I}_{xz} ( m ) ( \dot{r} - {D}_{13} pq + {D}_{14} qr ) - {TE}_{1} - {M}_{T}$$

$$\frac{1}{2} κ {p}_{0} δ {M}^{2} {Sc}_{w} {C}_{P} ( α , β , M , \hat{\dot{α}} , \hat{\dot{β}} , \hat{p} , \hat{q} , \hat{r} , {ɛ}_{h} , {ɛ}_{a} , {ɛ}_{r} , {ɛ}_{e} ) = {I}_{yy} ( m ) ( \dot{q} + {D}_{11} ( {p}^{2} - {r}^{2} ) + {D}_{12} pr ) - {TE}_{2} - {M}_{T} υ$$

$$\frac{1}{2} κ {p}_{0} δ {M}^{2} {Sb}_{w} {C}_{Y} ( α , β , M , \hat{\dot{α}} , \hat{\dot{β}} , \hat{p} , \hat{q} , \hat{r} , {ɛ}_{h} , {ɛ}_{a} , {ɛ}_{r} , {ɛ}_{e} ) = {I}_{xz} ( m ) ( \dot{p} - {D}_{9} pq + {D}_{10} qr ) + {I}_{zz} ( m ) ( \dot{r} - {D}_{13} pq + {D}_{14} qr ) - {TE}_{3} + {M}_{T} ɛ$$

To isolate longitudinal dynamics, it is assumed that AOS-on-rudder and bank-on-ailerons control loops are active to maintain the condition:

\dot{β}≡β≡0 [71]

p≡r≡0 [72]

If a steady coordinated level flight is held at given altitude δ, Mach M₀ and actual mass m₀, which requires certain known AOA α₀ (q≡\dot{α}≡0) and trim level ε_{h,0}, then expression [69] further reduces to:

½κp₀δM₀²Sc_{w}C_{P,0}=−T₀E₂+M_{T,0}υ=−W_{MTOW}δC_{T,0}E₂+m_{MTOW}b_{w}²N_{s,0}²C_{M}_{_{T}}υ [73]

where:

C_{p,0}=C_{P}(α₀,0,M₀,0,0,0,0,0,ε_{h,0},0,0,0) [74]

C_{T,0}=C_{T,0}(δ,θ,M₀,ε_{T,0}) [75]

If the elevator is actuated, an aerodynamic pitch moment appears, which breaks the balance and results in pitch acceleration; the expression that governs the longitudinal motion (after returning the elevator to the null position) reduces to:

½κp₀δM²Sc_{w}C_{P}(α,0,M,\dot{\hat{α}},0,0,\hat{q},0,εₕ,0,εᵣ,0)=I_{yy}(m)\dot{q}−TE₂+M_{T}υ=I_{yy}(m)\dot{q}−W_{MTOW}δC_{T}(δ,θ,M,ε_{T})E₂+m_{MTOW}b_{w}²Nₛ²C_{M}_{_{T}}υ [76]

Close enough to the balanced level flight condition and, as long as the flight is kept coordinated, εₑ is held null and ε_{h,0} is held constant, the aerodynamic pitch moment and thrust coefficients can be approximated by a Taylor expansion in the form (first order approach):

C_{P}(α,0,M,\dot{\hat{α}},0,0,\hat{q},0,ε_{h,0},0,εᵣ,0)=C_{P,0}+C_{P,α}Δα+C_{P}_{_{A}}_{,M}ΔM+C+C_{P,\dot{\hat{α}}}\dot{\hat{α}}+C_{P,\hat{q}}\hat{q}+C_{P,ε}_{ᵣ}εᵣ [77]

C_{T}(δ,θ,M,ε_{T,0})=C_{T,0}(δ,θ,M₀,ε_{T,0})+C_{T,M}(δ,θ,M₀,ε_{T,0})ΔM [78]

with:

$$Δα = α - {α}_{0}$$

$$Δ M = M - {M}_{0}$$

$${C}_{P , \hat{\dot{α}}} \hat{\dot{α}} = {C}_{P , \hat{\dot{α}}} \frac{\dot{α} {c}_{w}}{2 {v}_{TAS}} = {C}_{P , \hat{\dot{α}}} \frac{{c}_{w}}{2 {a}_{0}} \frac{\dot{α}}{M} = {C}_{P , \dot{α}} \frac{\dot{α}}{M}$$

$${C}_{P , \dot{α}} = {C}_{P , \hat{\dot{α}}} \frac{{c}_{w}}{2 {a}_{0}}$$

$${C}_{P , \hat{q}} \hat{q} = {C}_{P , \hat{q}} \frac{{qc}_{w}}{2 {v}_{TAS}} = {C}_{P , \hat{q}} \frac{{c}_{w}}{2 {a}_{0}} \frac{q}{M} = {C}_{P , q} \frac{q}{M}$$

$${C}_{P , q} = {C}_{P , \hat{q}} \frac{{c}_{w}}{2 {a}_{0}}$$

Assuming that the steady flight condition is perturbed with a longitudinal command (typically a so-called doublet) by means of the elevator and then return the elevator back to and hold it at the null position, without changing the throttle level (ε_{T,0} is held unchanged, thus, N_{s,0} does not change either), so the amplitude of the resulting oscillatory motion (the combination of the so-called short-term and the phugoid response modes) is small enough to allow approximating C_{P} and C_{T} by, respectively, expressions [77] and [78]:

$$\frac{1}{2} κ {p}_{0} δ {M}^{2} {Sc}_{w} ( {C}_{P , 0} + {C}_{P , α} Δα + {C}_{{P}_{A} , M} Δ M + {C}_{P , \dot{α}} \frac{\dot{α}}{M} + {C}_{P , q} \frac{q}{M} + {C}_{P , {ɛ}_{r}} {ɛ}_{r} ) = {I}_{yy} ( m ) \dot{q} - {W}_{MTOW} δ ( {C}_{T , 0} + {C}_{T , M} Δ M ) {E}_{2} + {m}_{MTOW} {b}_{w}^{2} {N}_{s , 0}^{2} {C}_{{M}_{T}} υ$$

$${M}^{2} = {( {M}_{0} + Δ M )}^{2} = {M}_{0}^{2} + 2 {M}_{0} Δ M + Δ {M}^{2} = {M}_{0}^{2} [ 1 + 2 \frac{Δ M}{{M}_{0}} + {( \frac{Δ M}{{M}_{0}} )}^{2} ]$$

$$\frac{Δ M}{{M}_{0}} ≪ 1$$

$${M}^{2} \approx {M}_{0}^{2} ( 1 + 2 \frac{Δ M}{{M}_{0}} )$$

$$\frac{1}{2} κ {p}_{0} δ ( {M}_{0}^{2} + 2 {M}_{0} Δ M ) {Sc}_{w} {C}_{P , 0} + \frac{1}{2} κ {p}_{0} δ {M}^{2} {Sc}_{w} ( {C}_{P , α} Δα + {C}_{{P}_{A} , M} Δ M + {C}_{P , \dot{α}} \frac{\dot{α}}{M} + {C}_{P , q} \frac{q}{M} + {C}_{P , {ɛ}_{r}} {ɛ}_{r} ) = {I}_{yy} ( m ) \dot{q} - {W}_{MTOW} δ ( {C}_{T , 0} + {C}_{T , M} Δ M ) {E}_{2} + {m}_{MTOW} {b}_{w}^{2} {N}_{s , 0}^{2} {C}_{{M}_{T}} υ$$

Bearing in mind expression [73], the longitudinal moments balance yields:

$$κ {p}_{0} δ {Sc}_{w} {M}_{0} Δ {MC}_{P , 0} + \frac{1}{2} κ {p}_{0} δ {M}^{2} {Sc}_{w} ( {C}_{P , α} Δα + {C}_{{P}_{A} , M} Δ M + {C}_{P , \dot{α}} \frac{\dot{α}}{M} + {C}_{P , q} \frac{q}{M} + {C}_{P , {ɛ}_{r}} {ɛ}_{r} ) = {I}_{yy} ( m ) \dot{q} - {W}_{MTOW} δ {C}_{T , M} Δ {ME}_{2}$$

$$κ {p}_{0} δ {Sc}_{w} {M}_{0} {C}_{P , 0} Δ M + \frac{1}{2} κ {p}_{0} δ {Sc}_{w} ( {M}^{2} {C}_{P , α} Δα + {M}^{2} {C}_{{P}_{A} , M} Δ M + {MC}_{P , \dot{α}} \dot{α} + {MC}_{P , q} q + {M}^{2} {C}_{P , {ɛ}_{r}} {ɛ}_{r} ) = {I}_{yy} ( m ) \dot{q} - {W}_{MTOW} δ {C}_{T , M} Δ {ME}_{2}$$

$${M}^{2} Δ M = {( {M}_{0} + Δ M )}^{2} Δ M = ( {M}_{0}^{2} + 2 {M}_{0} Δ M + Δ {M}^{2} ) Δ M = {M}_{0}^{2} [ 1 + 2 \frac{Δ M}{{M}_{0}} + {( \frac{Δ M}{{M}_{0}} )}^{2} ] Δ M \approx {M}_{0}^{2} ( 1 + 2 \frac{Δ M}{{M}_{0}} ) Δ M$$

$$\frac{1}{2} κ {p}_{0} δ {Sc}_{w} ( 2 {M}_{0} {C}_{P , 0} + \frac{{W}_{MTOW} {C}_{T , M} {E}_{2}}{\frac{1}{2} κ {P}_{0} {Sc}_{w}} ) Δ M + \frac{1}{2} κ {p}_{0} δ {Sc}_{w} [ {M}^{2} {C}_{P , α} Δα + {M}_{0}^{2} ( 1 + 2 \frac{Δ M}{{M}_{0}} ) {C}_{{P}_{A} , M} Δ M + {MC}_{P , \dot{α}} \dot{α} + {MC}_{P , q} q + {M}^{2} {C}_{P , {ɛ}_{r}} {ɛ}_{r} ] = {I}_{yy} ( m ) \dot{q}$$

$${C}_{P , M} = 2 \frac{{C}_{P , 0}}{{M}_{0}} + {C}_{{P}_{A} , M} + \frac{{W}_{MTOW} {C}_{T , M} {E}_{2}}{\frac{1}{2} κ {p}_{0} {Sc}_{w} {M}_{0}}$$

$$\frac{1}{2} κ {p}_{0} δ {Sc}_{w} ( {M}_{0}^{2} {C}_{P , M} Δ M + {M}^{2} {C}_{P , α} Δα + 2 {M}_{0} {C}_{{P}_{A} , M} Δ {M}^{2} + {MC}_{P , \dot{α}} \dot{α} + {MC}_{P , q} q + {M}^{2} {C}_{P , {ɛ}_{r}} {ɛ}_{r} ) = {I}_{yy} ( m ) \dot{q}$$

$$\frac{1}{2} κ {p}_{0} δ {Sc}_{w} [ {M}_{0}^{2} {C}_{P , M} Δ M + {M}_{0}^{2} ( 1 + 2 \frac{Δ M}{{M}_{0}} ) {C}_{P , α} Δα + 2 {M}_{0} {C}_{{P}_{A} , M} Δ {M}^{2} + ( {M}_{0} + Δ M ) {C}_{P , \dot{α}} \dot{α} + ( {M}_{0} + Δ M ) {C}_{P , q} q + {M}_{0}^{2} ( 1 + 2 \frac{Δ M}{{M}_{0}} ) {C}_{P , {ɛ}_{r}} {ɛ}_{r} ] = {I}_{yy} ( m ) \dot{q}$$

$$\frac{1}{2} κ {p}_{0} δ {Sc}_{w} [ {M}_{0}^{2} {C}_{P , M} Δ M + {M}_{0}^{2} {C}_{P , α} Δα + 2 {M}_{0} {C}_{{P}_{A} , M} ΔαΔ M + 2 {M}_{0} {C}_{{P}_{A} , M} Δ {M}^{2} + {M}_{0} {C}_{P , \dot{α}} \dot{α} + {C}_{P , \dot{α}} \dot{α} Δ M + {M}_{0} {C}_{P , q} q + {C}_{P , q} q Δ M + {M}_{0}^{2} {C}_{P , {ɛ}_{r}} {ɛ}_{r} + 2 {M}_{0} {C}_{P , {ɛ}_{r}} Δ M ] = {I}_{yy} ( m ) \dot{q}$$

$$\frac{1}{2} κ {p}_{0} δ {Sc}_{w} {M}_{0}^{2} [ {C}_{P , α} Δα + {C}_{P , M} Δ M + \frac{{C}_{P , \dot{α}}}{{M}_{0}} \dot{α} + \frac{{C}_{P , q}}{{M}_{0}} q + {C}_{P , {ɛ}_{r}} {ɛ}_{r} + ( 2 \frac{{C}_{P , α}}{{M}_{0}} Δα + 2 \frac{{C}_{{P}_{A} , M}}{{M}_{0}} Δ M + \frac{{C}_{P , \dot{α}}}{{M}_{0}^{2}} \dot{α} + \frac{{C}_{P , q}}{{M}_{0}^{2}} q + 2 \frac{{C}_{P , {ɛ}_{r}}}{{M}_{0}} {ɛ}_{r} ) Δ M ] = {I}_{yy} ( m ) \dot{q}$$

Expression [93] is a linear observer for the unknowns (C_{P,M}, C_{P,α}, C_{P}_{_{A}}_{,M}, C_{P,\dot{α}}, C_{P,q}, C_{P,ε}_{ᵣ}) and I_{yy}(m) valid for any Mach and actual mass. However, pitch acceleration \dot{q} and the derivative of the AOA, a are not typically native observables, which means numerical derivation should be required. To avoid the deriving noisy signals, a better idea is to integrate the known signals in [93] over time.

One possibility consists of neglecting the influence of a, which yields:

½κp₀δSc_{w}(M₀²C_{P,M}ΔM+M²C_{P,α}Δα+2M₀C_{P}_{_{A}}_{,M}ΔM²+MC_{P,q}q+M²C_{P,ε}_{ᵣ}εᵣ)=I_{yy}(m)\dot{q} [97]

f¹=∫ΔMdt

f²=∫M²Δαdt

f³=∫ΔM²dt

f⁴=∫Mqdt

f^{r}=∫M²εᵣdt [98]

½κp₀δSc_{w}(M₀²C_{P,M}f¹+C_{P,α}f²+2M₀C_{P}_{_{A}}_{,M}f³+C_{P,q}f⁴+C_{P,ε}_{ᵣ}f^{r})=I_{yy}(m)q+B [99]

Expression [99] is a linear observer for the unknowns {C_{P,M}, C_{P,α}, C_{P}_{_{A}}_{,M}, C_{P,q}, C_{P,ε}_{ᵣ}, B} and I_{yy}(m) valid for any Mach and actual mass, where B is an integration constant.

A second possibility consists on computing ∫M\dot{α} in [93] as:

∫M\dot{α}=∫Mα−∫\dot{M}α[Expression for \dot{M} TBD] [100]

The third possibility consists of eliminating the dependency with \dot{α} in [93] through, substituting expression [286] obtained from the linearization of the equations of linear motion, i.e.:

$$\frac{1}{2} κ {p}_{0} δ {Sc}_{w} [ {M}_{0}^{2} {C}_{P , M} Δ M + {M}^{2} {C}_{P , α} Δα + 2 {M}_{0} {C}_{{P}_{A} , M} Δ {M}^{2} + \frac{{C}_{P , \dot{α}}}{{F}_{4}} ( {M}_{0}^{2} {F}_{1} Δ M + {M}^{2} {F}_{2} Δα + {MF}_{3} q ) + {MC}_{P , q} q + {M}^{2} {C}_{P , {ɛ}_{r}} {ɛ}_{r} ] = {I}_{yy} ( m ) \dot{q} + {m}_{0} {c}_{w} \frac{{C}_{P , \dot{α}}}{{F}_{4}} ( {F}_{5} Δ {a}_{1}^{BFS} + {F}_{6} Δ {a}_{3}^{BFS} )$$

$$\frac{1}{2} κ {p}_{0} δ {Sc}_{w} [ {M}_{0}^{2} ( {C}_{P , M} + {C}_{P , \dot{α}} \frac{{F}_{1}}{{F}_{4}} ) Δ M + ( {C}_{P , α} + {C}_{P , \dot{α}} \frac{{F}_{2}}{{F}_{4}} ) {M}^{2} Δα + 2 {M}_{0} {C}_{{P}_{A} , M} Δ {M}^{2} + ( {C}_{P , q} + {C}_{P , \dot{α}} \frac{{F}_{3}}{{F}_{4}} ) Mq + {C}_{P , {ɛ}_{r}} {M}^{2} {ɛ}_{r} ] = {I}_{yy} ( m ) \dot{q} + {m}_{0} ( {C}_{P , \dot{α}} \frac{{F}_{5}}{{F}_{4}} {c}_{w} Δ {a}_{1}^{BFS} + {C}_{P , \dot{α}} \frac{{F}_{6}}{{F}_{4}} {c}_{w} Δ {a}_{3}^{BFS} )$$

$${G}_{1} = {C}_{P , M} + {C}_{P , \dot{α}} \frac{{F}_{1}}{{F}_{4}}$$

$${G}_{2} = {C}_{P , α} + {C}_{P , \dot{α}} \frac{{F}_{2}}{{F}_{4}}$$

$${G}_{3} = 2 {C}_{{P}_{A} , M}$$

$${G}_{4} = {C}_{P , q} + {C}_{P , \dot{α}} \frac{{F}_{3}}{{F}_{4}}$$

$${G}_{5} = {C}_{P , \dot{α}} \frac{{F}_{5}}{{F}_{4}} {c}_{w}$$

$${G}_{6} = {C}_{P , \dot{α}} \frac{{F}_{6}}{{F}_{4}} {c}_{w}$$

$$\frac{1}{2} κ {p}_{0} δ {Sc}_{w} [ {M}_{0}^{2} {G}_{1} Δ M + {G}_{2} {M}^{2} Δα + {M}_{0} {G}_{3} Δ {M}^{2} + {G}_{4} Mq + {C}_{P , {ɛ}_{r}} {M}^{2} {ɛ}_{r} ] = {I}_{yy} ( m ) \dot{q} + {m}_{0} ( {G}_{5} Δ {a}_{1}^{BFS} + {G}_{6} Δ {a}_{3}^{BFS} )$$

$${f}^{5} = \int Δ {a}_{1}^{BFS} dt$$

$${f}^{6} = \int Δ {a}_{3}^{BFS} dt$$

which allows rewriting expression [93] as:

½κp₀δSc_{w}[M₀²G₁f¹+G₂f²+M₀G₃f³+G₄f⁴+C_{P,∈}_{ᵣ}f^{r}]=I_{yy}(m)q+m₀(G_{5f}⁵+G₆f⁶)+B [106]

where B is an integration constant

Expression [106] is a linear observer for the unknowns {G₁, G₂, G₃, G₄, C_{P,ε}_{ᵣ}, G₅, G₆, B} and I_{yy}(m) valid for any Mach and actual mass. Thus by performing maneuvers for different cases of Mach at the trim condition and actual mass, an overdetermined linear observation system is obtained that allows estimating the mentioned unknowns. In effect, a case may be considered for the identification of I_{yy}(m) for the combination {mᵢ, Mⱼ}, i.e., at the trim condition at Mach Mⱼ (j=1, . . . , lᵢ) with actual mass mᵢ (i=1, . . . , k). For each case of Mⱼ, nⱼ samples of the response to a lateral perturbation are recorded. Thus:

$${H}_{ij} = [ \begin{matrix}\begin{matrix}- \frac{{q}_{j 1}}{\frac{1}{2} κ {p}_{0} δ {Sc}_{w}} & {M}_{j}^{2} {f}_{j 1}^{1} & {f}_{j 1}^{2} & {M}_{j} {f}_{j 1}^{3} & {f}_{j 1}^{4} & {f}_{j 1}^{r} & - \frac{{m}_{i} {f}_{j 1}^{5}}{\frac{1}{2} κ {p}_{0} δ {Sc}_{w}} & - \frac{{m}_{i} {f}_{j 1}^{6}}{\frac{1}{2} κ {p}_{0} δ {Sc}_{w}} & - \frac{1}{\frac{1}{2} κ {p}_{0} δ {Sc}_{w}}\end{matrix} \\ \begin{matrix}- \frac{{q}_{j 2}}{\frac{1}{2} κ {p}_{0} δ {Sc}_{w}} & {M}_{j}^{2} {f}_{j 2}^{1} & {f}_{j 2}^{2} & {M}_{j} {f}_{j 2}^{3} & {f}_{j 2}^{4} & {f}_{j 2}^{r} & - \frac{{m}_{i} {f}_{j 2}^{5}}{\frac{1}{2} κ {p}_{0} δ {Sc}_{w}} & - \frac{{m}_{i} {f}_{j 2}^{6}}{\frac{1}{2} κ {p}_{0} δ {Sc}_{w}} & - \frac{1}{\frac{1}{2} κ {p}_{0} δ {Sc}_{w}} \\ ⋮ & ⋮ & ⋮ & ⋮ & ⋮ & ⋮ & ⋮ & ⋮ & ⋮\end{matrix} \\ \begin{matrix} \\ \begin{matrix}- \frac{{q}_{{jn}_{j}}}{\frac{1}{2} κ {p}_{0} δ {Sc}_{w}} & {M}_{j}^{2} {f}_{{jn}_{j}}^{1} & {f}_{{jn}_{j}}^{2} & {M}_{j} {f}_{{jn}_{j}}^{3} & {f}_{{jn}_{j}}^{4} & {f}_{{jn}_{j}}^{r} & - \frac{{m}_{i} {f}_{{jn}_{j}}^{5}}{\frac{1}{2} κ {p}_{0} δ {Sc}_{w}} & - \frac{{m}_{i} {f}_{{jn}_{j}}^{6}}{\frac{1}{2} κ {p}_{0} δ {Sc}_{w}} & - \frac{1}{\frac{1}{2} κ {p}_{0} δ {Sc}_{w}}\end{matrix}\end{matrix}\end{matrix} ] {z}_{ij} = [ \begin{matrix}{I}_{yy} ( {m}_{i} ) \\ {G}_{1} ( {α}_{ij} , {M}_{j} , {ɛ}_{h , ij} ) \\ {G}_{2} ( {α}_{ij} , {M}_{j} , {ɛ}_{h , ij} ) \\ {G}_{3} ( {α}_{ij} , {M}_{j} , {ɛ}_{h , ij} ) \\ {G}_{4} ( {α}_{ij} , {M}_{j} , {ɛ}_{h , ij} ) \\ {C}_{P , {ɛ}_{r}} ( {α}_{ij} , {M}_{j} , {ɛ}_{h , ij} ) \\ {G}_{5} ( {α}_{ij} , {M}_{j} , {ɛ}_{h , ij} ) \\ {G}_{6} ( {α}_{ij} , {M}_{j} , {ɛ}_{h , ij} ) \\ {B}_{ij}\end{matrix} ] {O}_{ij} = [ \begin{matrix}0 \\ 0 \\ ⋮ \\ 0\end{matrix} ]$$

For the sake of robustness, I_{yy}(mᵢ) is obtained considering all the lᵢ samples as follows:

$${F}_{ij} = [ \begin{matrix}\begin{matrix}{M}_{j}^{2} {f}_{j 1}^{1} & {f}_{j 1}^{2} & {M}_{j} {f}_{j 1}^{3} & {f}_{j 1}^{4} & {f}_{j 1}^{r} & - \frac{{m}_{i} {f}_{j 1}^{5}}{\frac{1}{2} κ {p}_{0} δ {Sc}_{w}} & - \frac{{m}_{i} {f}_{j 1}^{6}}{\frac{1}{2} κ {p}_{0} δ {Sc}_{w}} & - \frac{1}{\frac{1}{2} κ {p}_{0} δ {Sc}_{w}}\end{matrix} \\ \begin{matrix}{M}_{j}^{2} {f}_{j 2}^{1} & {f}_{j 2}^{2} & {M}_{j} {f}_{j 2}^{3} & {f}_{j 2}^{4} & {f}_{j 2}^{r} & - \frac{{m}_{i} {f}_{j 2}^{5}}{\frac{1}{2} κ {p}_{0} δ {Sc}_{w}} & - \frac{{m}_{i} {f}_{j 2}^{6}}{\frac{1}{2} κ {p}_{0} δ {Sc}_{w}} & - \frac{1}{\frac{1}{2} κ {p}_{0} δ {Sc}_{w}} \\ ⋮ & ⋮ & ⋮ & ⋮ & ⋮ & ⋮ & ⋮ & ⋮\end{matrix} \\ \\ \begin{matrix}{M}_{j}^{2} {f}_{{jn}_{j}}^{1} & {f}_{{jn}_{j}}^{2} & {M}_{j} {f}_{{jn}_{j}}^{3} & {f}_{{jn}_{j}}^{4} & {f}_{{jn}_{j}}^{r} & - \frac{{m}_{i} {f}_{{jn}_{j}}^{5}}{\frac{1}{2} κ {p}_{0} δ {Sc}_{w}} & - \frac{{m}_{i} {f}_{{jn}_{j}}^{6}}{\frac{1}{2} κ {p}_{0} δ {Sc}_{w}} & - \frac{1}{\frac{1}{2} κ {p}_{0} δ {Sc}_{w}}\end{matrix}\end{matrix} ] {G}_{ij} = - \frac{1}{\frac{1}{2} κ {p}_{0} δ {Sc}_{w}} [ \begin{matrix}{q}_{j 1} \\ {q}_{j 2} \\ ⋮ \\ {q}_{{jn}_{j}}\end{matrix} ] \\ {C}_{P , ij} = [ \begin{matrix}{G}_{1} ( {α}_{ij} , {M}_{j} , {ɛ}_{h , ij} ) \\ {G}_{2} ( {α}_{ij} , {M}_{j} , {ɛ}_{h , ij} ) \\ {G}_{3} ( {α}_{ij} , {M}_{j} , {ɛ}_{h , ij} ) \\ {G}_{4} ( {α}_{ij} , {M}_{j} , {ɛ}_{h , ij} ) \\ {C}_{P , {ɛ}_{r}} ( {α}_{ij} , {M}_{j} , {ɛ}_{h , ij} ) \\ {G}_{5} ( {α}_{ij} , {M}_{j} , {ɛ}_{h , ij} ) \\ {G}_{6} ( {α}_{ij} , {M}_{j} , {ɛ}_{h , ij} ) \\ {B}_{ij}\end{matrix} ] {H}_{i} = [ \begin{matrix}{G}_{i 1} & {F}_{i 1} & 0 & … & 0 \\ {G}_{i 2} & 0 & {F}_{i 2} & … & 0 \\ ⋮ & ⋮ & ⋮ & & ⋮ \\ {G}_{{il}_{i}} & 0 & 0 & … & {F}_{{il}_{i}}\end{matrix} ] dim ( {H}_{i} ) = ( {\sum }_{j = 1}^{{l}_{i}} {n}_{j} ) \times ( 1 + 8 {l}_{i} ) {z}_{i} = [ \begin{matrix}{I}_{yy} ( {m}_{i} ) \\ {C}_{P , i 1} \\ {C}_{P , i 2} \\ ⋮ \\ {C}_{P , {il}_{i}}\end{matrix} ] dim ( {z}_{i} ) = ( 1 + 8 {l}_{i} ) \times 1 \\ {O}_{i} = [ \begin{matrix}0 \\ 0 \\ ⋮ \\ 0\end{matrix} ] dim ( {O}_{i} ) = ( {\sum }_{j = 1}^{{l}_{i}} {n}_{j} ) \times 1 {z}_{i} = {( {H}_{i}^{T} {H}_{i} )}^{- 1} {H}_{i}^{T} {O}_{i} {I}_{yy} ( {m}_{i} ) = {z}_{i} [ 1 ]$$

Repeating the maneuvers for different values of the actual mass would render the variation of I_{yy} with m as I_{yy}=f(mᵢ) for i=1, . . . , k

Now, to isolate lateral dynamics, it is assumed that a new pitch rate-on-elevator control loop is active to ensure q≡0. If a steady level flight is held at given Mach M and actual mass m, which requires certain known AOA α₀ (q≡\dot{α}≡0) and trim level ε_{h,0}, then expressions [68] and [69] further reduce to:

½κp₀δM²Sb_{w}C_{R,0}=−T₀E₁−M_{T,0}=−W_{MTOW}δC_{T,0}E₁−m_{MTOW}b_{w}N_{s,0}²C_{M}_{_{T}} [118]

½κp₀δM²Sb_{w}C_{Y,0}=−T₀E₃+M_{T,0}ε=−W_{MTOW}δC_{T,0}E₃+m_{MTOW}b_{w}²N_{s,0}²C_{M}_{_{T}}ε [119]

where:

C_{R,0}=C_{R}(α₀,0,M₀,0,0,0,0,0,ε_{h,0},0,0,0) [120]

C_{Y,0}=C_{Y}(α₀,0,M₀,0,0,0,0,0,ε_{h,0},0,0,0) [121]

If the ailerons are actuated, an aerodynamic roll moment appears, which breaks the balance and results in roll acceleration; expression [68] reduces in that case to:

$$\frac{1}{2} κ {p}_{0} δ {M}^{2} {Sb}_{w} {C}_{R} ( α , β , M , 0 , \hat{\dot{β}} , \hat{p} , 0 , \hat{r} , {ɛ}_{h , 0} , 0 , 0 , 0 ) = {I}_{xx} ( m ) \dot{p} - {I}_{xz} ( m ) \dot{r} - {TE}_{1} - {M}_{T} == {I}_{xx} ( m ) \dot{p} - {I}_{xz} ( m ) \dot{r} - {W}_{MTOW} δ {C}_{T} ( δ , θ , M , {ɛ}_{T} ) {E}_{1} - {m}_{MTOW} {b}_{w}^{2} {N}_{s}^{2} {C}_{{M}_{T}} \qquad [ 122 ]$$

Close enough to the balanced flight condition and, as long as εₐ and εᵣ are held null and, ε_{h,0} is held constant, the aerodynamic roll moment coefficient can be approximated by a Taylor expansion in the form:

C_{R}(α,β,M,0,\dot{\hat{β}},\hat{p},0,\hat{r},ε_{h,0},0,0,0)=C_{R,0}+C_{R,α}Δα+C_{R,β}β+C_{R}_{_{A}}_{,β}β+C_{R}_{_{A}}_{,M}ΔM+C_{R,\dot{\hat{β}}}\dot{\hat{β}}+C_{R,\hat{p}}\hat{p}+C_{R,\hat{f}}\hat{r} [123]

with:

$${C}_{R , \hat{\dot{β}}} \hat{\dot{β}} = {C}_{R , \hat{\dot{β}}} \frac{\dot{β} {b}_{w}}{2 {v}_{TAS}} = {C}_{R , \hat{\dot{β}}} \frac{{b}_{w}}{2 {a}_{0}} \frac{\dot{β}}{M} = {C}_{R , \dot{β}} \frac{\dot{β}}{M}$$

$${C}_{R , \dot{β}} {C}_{R , \hat{\dot{β}}} \frac{{b}_{w}}{2 {a}_{0}}$$

$${C}_{R , \hat{p}} \hat{p} = {C}_{R , \hat{p}} \frac{{pb}_{w}}{2 {v}_{TAS}} = {C}_{R , \hat{p}} \frac{{b}_{w}}{2 {a}_{0}} \frac{p}{M} = {C}_{R , p} \frac{p}{M}$$

$${C}_{P , p} = {C}_{R , \hat{p}} \frac{{b}_{w}}{2 {a}_{0}}$$

$${C}_{R , \hat{r}} \hat{r} = {C}_{R , \hat{r}} \frac{{rb}_{w}}{2 {v}_{TAS}} = {C}_{R , \hat{r}} \frac{{b}_{w}}{2 {a}_{0}} \frac{r}{M} = {C}_{R , r} \frac{r}{M}$$

$${C}_{P , r} = {C}_{R , \hat{r}} \frac{{b}_{w}}{2 {a}_{0}}$$

Analogously, if the rudder is actuated from the balanced condition, an aerodynamic yaw moment appears, which breaks the balance and results in yaw acceleration; expression [70] reduces in that case to:

$$\frac{1}{2} κ {p}_{0} δ {M}^{2} {Sb}_{w} {C}_{Y} ( α , β , M , 0 , \hat{\dot{β}} , \hat{p} , 0 , \hat{r} , {ɛ}_{h , 0} , 0 , 0 , 0 ) = - {I}_{xz} ( m ) \dot{p} + {I}_{zz} ( m ) \dot{r} - {TE}_{3} + {M}_{T} ɛ = - {I}_{xz} ( m ) \dot{p} + {I}_{zz} ( m ) \dot{r} - {W}_{MTOW} δ {C}_{T} ( δ , θ , M , {ɛ}_{T} ) {E}_{3} + {m}_{MTOW} {b}_{w}^{2} {N}_{s}^{2} {C}_{{M}_{T}} ɛ \qquad [ 127 ]$$

Again, close enough to the balanced flight condition and, as long as εₐ and εᵣ are held null and, ε_{h,0} is held constant, the aerodynamic yaw moment coefficient can be approximated by a Taylor expansion in the form:

C_{Y}(β,\hat{p},\hat{r},εₐ,εᵣ)=C_{Y,0}+C_{Y,α}Δα+C_{Y,β}β+C_{Y}_{_{A}}_{,M}ΔM+C_{Y,\dot{\hat{β}}}\dot{\hat{β}}+C_{Y,\hat{p}}\hat{p}+C_{Y,\hat{r}}\hat{r} [128]

with:

$${C}_{Y , \hat{\dot{β}}} \hat{\dot{β}} = {C}_{Y , \hat{\dot{β}}} \frac{\dot{β} {b}_{w}}{2 {v}_{TAS}} = {C}_{Y , \hat{\dot{β}}} \frac{{b}_{w}}{2 {a}_{0}} \frac{\dot{β}}{M} = {C}_{Y , \dot{β}} \frac{\dot{β}}{M}$$

$${C}_{Y , \dot{β}} {C}_{Y , \hat{\dot{β}}} \frac{{b}_{w}}{2 {a}_{0}}$$

$${C}_{Y , \hat{p}} \hat{p} = {C}_{Y , \hat{p}} \frac{{pb}_{w}}{2 {v}_{TAS}} = {C}_{Y , \hat{p}} \frac{{b}_{w}}{2 {a}_{0}} \frac{p}{M} = {C}_{Y , p} \frac{p}{M}$$

$${C}_{Y , p} = {C}_{Y , \hat{p}} \frac{{b}_{w}}{2 {a}_{0}}$$

$${C}_{Y , \hat{r}} \hat{r} = {C}_{Y , \hat{r}} \frac{{rb}_{w}}{2 {v}_{TAS}} = {C}_{Y , \hat{r}} \frac{{b}_{w}}{2 {a}_{0}} \frac{r}{M} = {C}_{Y , r} \frac{r}{M}$$

$${C}_{Y , r} = {C}_{Y , \hat{r}} \frac{{b}_{w}}{2 {a}_{0}}$$

In both cases:

C_{T}(δ,θ,M,ε_{T,0})=C_{T,0}(δ,θ,M₀,ε_{T,0})+C_{T,M}(δ,θ,M₀,ε_{T,0})ΔM [132]

Expressions [122] and [127] along with the respective coefficients from [123], [128] and [132] govern the lateral-directional motion in the cases described, regardless that the perturbation that triggers such motion comes from ailerons or rudder actuations as rolling and yawing motions are coupled.

It is assumed that perturbation of the steady flight condition with a lateral-directional command (typically a so-called doublet) by means of either ailerons or rudder and then return the given control surface back to and hold it at the null position so the amplitude of the resulting oscillatory motion (in general, a combination of the so-called roll, Dutch roll and spiral response modes) is small enough to allow approximating C_{R} and C_{y} by, respectively expressions [123] and [128]:

$$\begin{matrix}\frac{1}{2} κ {p}_{0} δ {M}^{2} {Sb}_{w} ( {C}_{R , 0} + {C}_{R , α} Δ α + {C}_{R , β} β + {C}_{{R}_{A} , M} Δ M + {C}_{R , \dot{β}} \frac{\dot{β}}{M} + {C}_{R , p} \frac{p}{M} + {C}_{R , r} \frac{r}{M} ) = {I}_{xx} ( m ) \dot{p} - {I}_{xz} ( m ) \dot{r} - {W}_{MTOW} δ ( {C}_{T , 0} + {C}_{T , M} Δ M ) {E}_{1} - {m}_{MTOW} {b}_{w}^{2} {N}_{s , 0}^{2} {C}_{{M}_{T}} & [ 133 ] \\ \frac{1}{2} κ {p}_{0} δ {M}^{2} {Sb}_{w} ( {C}_{Y , 0} + {C}_{Y , α} Δ α + {C}_{Y , β} β + {C}_{{Y}_{A} , M} Δ M + {C}_{Y , \dot{β}} \frac{\dot{β}}{M} + {C}_{Y , p} \frac{p}{M} + {C}_{Y , r} \frac{r}{M} ) = - {I}_{xz} ( m ) \dot{p} + {I}_{zz} ( m ) \dot{r} - {W}_{MTOW} δ ( {C}_{T , 0} + {C}_{T , M} Δ M ) {E}_{3} + {m}_{MTOW} {b}_{w}^{2} {N}_{s , 0}^{2} {C}_{{M}_{T}} ɛ & [ 134 ]\end{matrix}$$

If expressions [84], [85] and [86] are taken into account:

$$\begin{matrix}\frac{1}{2} κ {p}_{0} δ ( {M}_{0}^{2} + 2 {M}_{0} Δ M ) {Sb}_{w} {C}_{R , 0} + \frac{1}{2} κ {p}_{0} δ {M}^{2} {Sb}_{w} ( {C}_{R , α} Δ α + {C}_{R , β} β + {C}_{{R}_{A} , M} Δ M + {C}_{R , \dot{β}} \frac{\dot{β}}{M} + {C}_{R , p} \frac{p}{M} + {C}_{R , r} \frac{r}{M} ) = {I}_{xx} ( m ) \dot{p} - {I}_{xz} ( m ) \dot{r} - {W}_{MTOW} δ ( {C}_{T , 0} + {C}_{T , M} Δ M ) {E}_{1} - {m}_{MTOW} {b}_{w}^{2} {N}_{s , 0}^{2} {C}_{{M}_{T}} & [ 135 ] \\ \frac{1}{2} κ {p}_{0} δ ( {M}_{0}^{2} + 2 {M}_{0} Δ M ) {Sb}_{w} {C}_{Y , 0} + \frac{1}{2} κ {p}_{0} δ {M}^{2} {Sb}_{w} ( {C}_{Y , α} Δ α + {C}_{Y , β} β + {C}_{{Y}_{A} , M} Δ M + {C}_{Y , \dot{β}} \frac{\dot{β}}{M} + {C}_{Y , p} \frac{p}{M} + {C}_{Y , r} \frac{r}{M} ) = - {I}_{xz} ( m ) \dot{p} + {I}_{zz} ( m ) \dot{r} - {W}_{MTOW} δ ( {C}_{T , 0} + {C}_{T , M} Δ M ) {E}_{3} + {m}_{MTOW} {b}_{w}^{2} {N}_{s , 0}^{2} {C}_{{M}_{T}} ɛ & [ 136 ]\end{matrix}$$

Bearing in mind expressions [118] and [119], the lateral-directional moments balance yields:

$$\begin{matrix}κ {p}_{0} δ {M}_{0} Δ {MSb}_{w} {C}_{R , 0} + \frac{1}{2} κ {p}_{0} δ {M}^{2} {Sb}_{w} ( {C}_{R , α} Δ α + {C}_{R , β} β + {C}_{{R}_{A} , M} Δ M + {C}_{R , \dot{β}} \frac{\dot{β}}{M} + {C}_{R , p} \frac{p}{M} + {C}_{R , r} \frac{r}{M} ) = {I}_{xx} ( m ) \dot{p} - {I}_{xz} ( m ) \dot{r} - {W}_{MTOW} δ {C}_{T , M} Δ {ME}_{1} & [ 137 ] \\ κ {p}_{0} δ {M}_{0} Δ {MSb}_{w} {C}_{Y , 0} + \frac{1}{2} κ {p}_{0} δ {M}^{2} {Sb}_{w} ( {C}_{Y , α} Δ α + {C}_{Y , β} β + {C}_{{Y}_{A} , M} Δ M + {C}_{Y , \dot{β}} \frac{\dot{β}}{M} + {C}_{Y , p} \frac{p}{M} + {C}_{Y , r} \frac{r}{M} ) = - {I}_{xz} ( m ) \dot{p} + {I}_{zz} ( m ) \dot{r} - {W}_{MTOW} δ {C}_{T , M} Δ {ME}_{3} & [ 138 ] \\ κ {p}_{0} δ {M}_{0} {Sb}_{w} {C}_{R , 0} Δ M + \frac{1}{2} κ {p}_{0} δ {Sb}_{w} ( {M}^{2} {C}_{R , α} Δ α + {M}^{2} {C}_{R , β} β + {M}^{2} {C}_{{R}_{A} , M} Δ M + {MC}_{R , \dot{β}} \dot{β} + {MC}_{R , p} p + {MC}_{R , r} r ) = {I}_{xx} ( m ) \dot{p} - {I}_{xz} ( m ) \dot{r} - {W}_{MTOW} δ {C}_{T , M} Δ {ME}_{1} & [ 139 ] \\ κ {p}_{0} δ {M}_{0} {Sb}_{w} {C}_{Y , 0} Δ M + \frac{1}{2} κ {p}_{0} δ {Sb}_{w} ( {M}^{2} {C}_{Y , α} Δ α + {M}^{2} {C}_{Y , β} β + {M}^{2} {C}_{{Y}_{A} , M} Δ M + {MC}_{Y , \dot{β}} \dot{β} + {MC}_{Y , p} p + {MC}_{Y , r} r ) = - {I}_{xz} ( m ) \dot{p} + {I}_{zz} ( m ) \dot{r} - {W}_{MTOW} δ {C}_{T , M} Δ {ME}_{3} & [ 140 ] \\ κ {p}_{0} δ {M}_{0} {Sb}_{w} {C}_{R , 0} Δ M + \frac{1}{2} κ {p}_{0} δ {Sb}_{w} ( {M}^{2} {C}_{R , α} Δ α + {M}^{2} {C}_{R , β} β + {M}^{2} {C}_{{R}_{A} , M} Δ M + {MC}_{R , \dot{β}} \dot{β} + {MC}_{R , p} p + {MC}_{R , r} r ) = {I}_{xx} ( m ) \dot{p} - {I}_{xz} ( m ) \dot{r} - {W}_{MTOW} δ {C}_{T , M} Δ {ME}_{1} & [ 141 ] \\ κ {p}_{0} δ {M}_{0} {Sb}_{w} {C}_{Y , 0} Δ M + \frac{1}{2} κ {p}_{0} δ {Sb}_{w} ( {M}^{2} {C}_{Y , α} Δ α + {M}^{2} {C}_{Y , β} β + {M}^{2} {C}_{{Y}_{A} , M} Δ M + {MC}_{Y , \dot{β}} \dot{β} + {MC}_{Y , p} p + {MC}_{Y , r} r ) = - {I}_{xz} ( m ) \dot{p} + {I}_{zz} ( m ) \dot{r} - {W}_{MTOW} δ {C}_{T , M} Δ {ME}_{3} & [ 142 ]\end{matrix}$$

Taking into account approximation [90]:

$$\begin{matrix}\frac{1}{2} κ {p}_{0} δ {Sb}_{w} ( 2 {M}_{0} {C}_{R , 0} + \frac{{W}_{MTOW} {C}_{T , M} {E}_{1}}{\frac{1}{2} κ {p}_{0} {Sc}_{w}} ) Δ M + \frac{1}{2} κ {p}_{0} δ {Sb}_{w} ( {M}^{2} {C}_{R , α} Δ α + {M}^{2} {C}_{R , β} β + {M}_{0}^{2} ( 1 + 2 \frac{Δ M}{{M}_{0}} ) {C}_{{R}_{A} , M} Δ M + {MC}_{R , \dot{β}} \dot{β} + {MC}_{R , p} p + {MC}_{R , r} r ) = {I}_{xx} ( m ) \dot{p} - {I}_{xz} ( m ) \dot{r} & [ 143 ] \\ \frac{1}{2} κ {p}_{0} δ {Sb}_{w} ( 2 {M}_{0} {C}_{Y , 0} + \frac{{W}_{MTOW} {C}_{T , M} {E}_{3}}{\frac{1}{2} κ {p}_{0} {Sc}_{w}} ) Δ M + \frac{1}{2} κ {p}_{0} δ {Sb}_{w} ( {M}^{2} {C}_{Y , α} Δ α + {M}^{2} {C}_{Y , β} β + {M}_{0}^{2} ( 1 + 2 \frac{Δ M}{{M}_{0}} ) {C}_{{Y}_{A} , M} Δ M + {MC}_{Y , \dot{β}} \dot{β} + {MC}_{Y , p} p + {MC}_{Y , r} r ) = - {I}_{xz} ( m ) \dot{p} + {I}_{zz} ( m ) \dot{r} & [ 144 ] \\ {C}_{R , M} = 2 \frac{{C}_{R , 0}}{{M}_{0}} + {C}_{{R}_{A} , M} + \frac{{W}_{MTOW} {C}_{T , M} {E}_{1}}{\frac{1}{2} κ {p}_{0} {Sc}_{w} {M}_{0}^{2}} & [ 145 ] \\ {C}_{Y , M} = 2 \frac{{C}_{Y , 0}}{{M}_{0}} + {C}_{{Y}_{A} , M} + \frac{{W}_{MTOW} {C}_{T , M} {E}_{3}}{\frac{1}{2} κ {p}_{0} {Sc}_{w} {M}_{0}^{2}} & [ 146 ] \\ \frac{1}{2} κ {p}_{0} δ {Sb}_{w} ( {M}_{0}^{2} {C}_{R , M} Δ M + {M}^{2} {C}_{R , α} Δ α + {M}^{2} {C}_{R , β} β + 2 {M}_{0} {C}_{{R}_{A} , M} Δ {M}^{2} + {MC}_{R , \dot{β}} \dot{β} + {MC}_{R , p} p + {MC}_{R , r} r ) = {I}_{xx} ( m ) \dot{p} - {I}_{xz} ( m ) \dot{r} & [ 147 ] \\ \frac{1}{2} κ {p}_{0} δ {Sb}_{w} ( {M}_{0}^{2} {C}_{Y , M} Δ M + {M}^{2} {C}_{Y , α} Δ α + {M}^{2} {C}_{Y , β} β + 2 {M}_{0} {C}_{{R}_{A} , M} Δ {M}^{2} + {MC}_{Y , \dot{β}} \dot{β} + {MC}_{Y , p} p + {MC}_{Y , r} r ) = - {I}_{xz} ( m ) \dot{p} + {I}_{zz} ( m ) \dot{r} & [ 148 ] \\ \frac{1}{2} κ {p}_{0} δ {Sb}_{w} [ {M}_{0}^{2} {C}_{R , M} Δ M + {M}_{0}^{2} ( 1 + 2 \frac{Δ M}{{M}_{0}} ) {C}_{R , α} Δα + {M}_{0}^{2} ( 1 + 2 \frac{Δ M}{{M}_{0}} ) {C}_{R , β} β + 2 {M}_{0} {C}_{{R}_{A} , M} Δ {M}^{2} + ( {M}_{0} + Δ M ) {C}_{R , \dot{β}} \dot{β} + ( {M}_{0} + Δ M ) {C}_{R , p} p + ( {M}_{0} + Δ M ) {C}_{R , r} r ] = {I}_{xx} ( m ) \dot{p} - {I}_{xz} ( m ) \dot{r} & [ 149 ] \\ \frac{1}{2} κ {p}_{0} δ {Sb}_{w} [ {M}_{0}^{2} {C}_{Y , M} Δ M + {M}_{0}^{2} ( 1 + 2 \frac{Δ M}{{M}_{0}} ) {C}_{Y , α} Δα + {M}_{0}^{2} ( 1 + 2 \frac{Δ M}{{M}_{0}} ) {C}_{Y , β} β + 2 {M}_{0} {C}_{{R}_{A} , M} Δ {M}^{2} + ( {M}_{0} + Δ M ) {C}_{Y , \dot{β}} \dot{β} + ( {M}_{0} + Δ M ) {C}_{Y , p} p + ( {M}_{0} + Δ M ) {C}_{Y , r} r ] = - {I}_{xz} ( m ) \dot{p} + {I}_{zz} ( m ) \dot{r} & [ 150 ] \\ \frac{1}{2} κ {p}_{0} δ {Sb}_{w} {M}_{0}^{2} [ {C}_{R , α} Δ α + {C}_{R , β} β + {C}_{R , M} Δ M + \frac{{C}_{R , \dot{β}}}{{M}_{0}} \dot{β} + \frac{{C}_{R , p}}{{M}_{0}} p + \frac{{C}_{R , r}}{{M}_{0}} r + ( 2 \frac{{C}_{R , α}}{{M}_{0}} Δ α + 2 \frac{{C}_{R , β} β}{{M}_{0}} β + 2 \frac{{C}_{{R}_{A} , M}}{{M}_{0}} Δ M + \frac{{C}_{R , \dot{β}}}{{M}_{0}^{2}} \dot{β} + \frac{{C}_{R , p}}{{M}_{0}^{2}} p + \frac{{C}_{R , r}}{{M}_{0}^{2}} r ) Δ M ] = {I}_{xx} ( m ) \dot{p} - {I}_{xz} ( m ) \dot{r} & [ 151 ] \\ \frac{1}{2} κ {p}_{0} δ {Sb}_{w} {M}_{0}^{2} [ {C}_{Y , α} Δ α + {C}_{Y , β} β + {C}_{Y , M} Δ M + \frac{{C}_{Y , \dot{β}}}{{M}_{0}} \dot{β} + \frac{{C}_{Y , p}}{{M}_{0}} p + \frac{{C}_{Y , r}}{{M}_{0}} r + ( 2 \frac{{C}_{Y , α}}{{M}_{0}} Δ α + 2 \frac{{C}_{Y , β} β}{{M}_{0}} β + 2 \frac{{C}_{{Y}_{A} , M}}{{M}_{0}} Δ M + \frac{{C}_{Y , \dot{β}}}{{M}_{0}^{2}} \dot{β} + \frac{{C}_{Y , p}}{{M}_{0}^{2}} p + \frac{{C}_{Y , r}}{{M}_{0}^{2}} r ) Δ M ] = {I}_{xz} ( m ) \dot{p} + {I}_{zz} ( m ) \dot{r} & [ 152 ]\end{matrix}$$

Expressions [147] and [148] constitute a linear observer for the unknowns {C_{R,M}, C_{R,α}, C_{R,β}, C_{R}_{_{A}}_{,M}, C_{R,\dot{β}}, C_{R,p}, C_{R,r}, C_{Y,M}, C_{Y,α}, C_{Y,β}, C_{Y}_{_{A}}_{,M}, C_{Y,\dot{β}}, C_{Y,p}, C_{Y,r}} and {Iₓₓ(m),I_{xz}(m),I_{zz}(m)_{}} valid for any Mach and actual mass. However, roll and yaw accelerations \dot{p} and \dot{r} and the derivative of the AOS, \dot{β} are not typically native observables, which means numerical derivation should be required. To avoid the deriving noisy signals, a better idea is to integrate the known signals in [147] and [148] over time. Again, one option consists of neglecting the influence of \dot{β}, which yields:

½κp₀δSb_{w}(M₀²C_{R,M}ΔM+M²C_{R,α}Δα+M²C_{R,β}β+2M₀C_{R}_{_{A,M}}ΔM²+MC_{R,p}p+MC_{R,r}r)=Iₓₓ(m)\dot{p}−I_{xz}(m)\dot{r} [153]

½κp₀δSb_{w}(M₀²C_{Y,M}ΔM+M²C_{Y,α}Δα+M²C_{Y,β}β+2M₀C_{R}_{_{A,M}}ΔM²+MC_{Y,p}p+MC_{Y,r}r)=Iₓₓ(m)\dot{p}−I_{xz}(m)\dot{r} [154]

f¹=∫ΔMdt

f²=∫M²Δαdt

f³=∫M²βdt

f⁴=∫ΔM²dt

f⁵=∫Mpdt

f⁶=∫Mrdt [155]

½κp₀δSb_{w}(M₀²C_{R,M}f¹+C_{R,α}f²+C_{R,β}f³+2M₀C_{R}_{_{A}}_{,M}f⁴+C_{R,p}f⁵+C_{R,r}f⁶)=Iₓₓ(m)\dot{p}−I_{xz}(m)\dot{r}+A [156]

½κp₀δSb_{w}(M₀²C_{Y,M}f¹+C_{Y,α}f²+C_{Y,β}f³+2M₀C_{R}_{_{A}}_{,M}f⁴+C_{Y,p}f⁵+C_{Y,r}f⁶)=Iₓₓ(m)\dot{p}−I_{xz}(m)\dot{r}+A [157]

Expressions [156] and [157] constitute a linear observer for the unknowns {C_{R,M}, C_{R,α}, C_{R,β}, C_{R}_{_{A}}_{,M}, C_{R,p}, C_{R,r}, A, C_{Y,M}, C_{Y,α}, C_{Y,β}, C_{Y}_{_{A}}_{,M}, C_{Y,p}, C_{Y,r}, C} and {Iₓₓ(m),I_{xz}(m),I_{zz}(m)} valid for any Mach and actual mass, where A and C are integration constants.

A second possibility consists on computing ∫M\dot{β} in expressions [147] and [148] as:

∫M\dot{β}=∫Mβ−∫\dot{M}β [Expression for \dot{M} TBD] [158]

The third possibility consists of eliminating the dependency with \dot{β} in [147] and [148][93] through, substituting expression [315] obtained from the linearization of the equations of linear motion, i.e.:

$$\begin{matrix} {F}_{1} = {C}_{R , M} - {C}_{R , \dot{β}} \frac{{C}_{y , M}}{{C}_{Q , \dot{β}}} \\ {F}_{2} = {C}_{R , α} - {C}_{R , \dot{β}} \frac{{C}_{Q , α}}{{C}_{Q , \dot{β}}} \\ {F}_{3} = {C}_{R , β} - {C}_{R , \dot{β}} \frac{{C}_{Q , β}}{{C}_{Q , \dot{β}}} \\ {F}_{4} = 2 ( {C}_{{R}_{A} , M} - {C}_{R , \dot{β}} \frac{{C}_{Q , M}}{{C}_{Q , \dot{β}}} ) \\ {F}_{5} = {C}_{R , p} - {C}_{R , \dot{β}} \frac{{C}_{Q , p}}{{C}_{Q , \dot{β}}} \\ {F}_{6} = {C}_{R , r} - {C}_{R , \dot{β}} \frac{{C}_{Q , r}}{{C}_{Q , \dot{β}}} \\ {F}_{7} = - {C}_{R , \dot{β}} \frac{{C}_{D , α}}{{C}_{Q , \dot{β}}} \\ {F}_{8} = - {C}_{R , \dot{β}} \frac{{C}_{D , β}}{{C}_{Q , \dot{β}}} \\ {F}_{9} = - {C}_{R , \dot{β}} \frac{{C}_{D , M}}{{C}_{Q , \dot{β}}} \\ {F}_{10} = - {C}_{R , \dot{β}} \frac{{C}_{D , p}}{{C}_{Q , \dot{β}}} \\ {F}_{11} = - {C}_{R , \dot{β}} \frac{{C}_{D , r}}{{C}_{Q , \dot{β}}} \\ {F}_{12} = {C}_{R , \dot{β}} \frac{1}{{C}_{Q , \dot{β}}} {b}_{w} & [ 159 ] \\ {G}_{1} = {C}_{Y , M} - {C}_{Y , \dot{β}} \frac{{C}_{y , M}}{{C}_{Q , \dot{β}}} \\ {G}_{2} = {C}_{Y , α} - {C}_{Y , \dot{β}} \frac{{C}_{Q , α}}{{C}_{Q , \dot{β}}} \\ {G}_{3} = {C}_{Y , β} - {C}_{Y , \dot{β}} \frac{{C}_{Q , β}}{{C}_{Q , \dot{β}}} \\ {G}_{4} = 2 ( {C}_{{Y}_{A} , M} - {C}_{Y , \dot{β}} \frac{{C}_{Q , M}}{{C}_{Q , \dot{β}}} ) \\ {G}_{5} = {C}_{Y , p} - {C}_{Y , \dot{β}} \frac{{C}_{Q , p}}{{C}_{Q , \dot{β}}} \\ {G}_{6} = {C}_{Y , r} - {C}_{Y , \dot{β}} \frac{{C}_{Q , r}}{{C}_{Q , \dot{β}}} \\ {G}_{7} = - {C}_{Y , \dot{β}} \frac{{C}_{D , α}}{{C}_{Q , \dot{β}}} \\ {G}_{8} = - {C}_{Y , \dot{β}} \frac{{C}_{D , β}}{{C}_{Q , \dot{β}}} \\ {G}_{9} = - {C}_{Y , \dot{β}} \frac{{C}_{D , M}}{{C}_{Q , \dot{β}}} \\ {G}_{10} = - {C}_{Y , \dot{β}} \frac{{C}_{D , p}}{{C}_{Q , \dot{β}}} \\ {G}_{11} = - {C}_{Y , \dot{β}} \frac{{C}_{D , r}}{{C}_{Q , \dot{β}}} \\ {G}_{12} = {C}_{Y , \dot{β}} \frac{1}{{C}_{Q , \dot{β}}} {b}_{w} & [ 160 ] \\ \frac{1}{2} κ {p}_{0} δ {Sb}_{w} ( {M}_{0}^{2} {F}_{1} Δ M + {F}_{2} {M}^{2} Δ α + {F}_{3} {M}^{2} β + {M}_{0} {F}_{4} Δ {M}^{2} + {F}_{5} Mp + {F}_{6} Mr + {F}_{7} {M}^{2} β Δ α + {F}_{8} {M}^{2} {β}^{2} + {F}_{9} {M}^{2} β Δ M + {F}_{10} Mp β + {F}_{11} Mr β ) = {I}_{xx} ( m ) \dot{p} - {I}_{xz} ( m ) \dot{r} + {m}_{0} {F}_{12} Δ {a}_{2}^{BFS} & [ 161 ] \\ \frac{1}{2} κ {p}_{0} δ {Sb}_{w} ( {M}_{0}^{2} {G}_{1} Δ M + {G}_{2} {M}^{2} Δ α + {G}_{3} {M}^{2} β + {M}_{0} {G}_{4} Δ {M}^{2} + {G}_{5} Mp + {G}_{6} Mr + {G}_{7} {M}^{2} β Δ α + {G}_{8} {M}^{2} {β}^{2} + {G}_{9} {M}^{2} β Δ M + {G}_{10} Mp β + {G}_{11} Mr β ) = - {I}_{xz} ( m ) \dot{p} + {I}_{zz} ( m ) \dot{r} + {m}_{0} {G}_{12} Δ {a}_{2}^{BFS} & [ 162 ] \\ {f}^{7} = \int {M}^{2} βΔ α dt \\ {f}^{8} = \int {M}^{2} {β}^{2} dt \\ {f}^{9} = \int {M}^{2} βΔ Mdt \\ {f}^{10} = \int Mp β dt \\ {f}^{11} = \int Mr β dt \\ {f}^{12} = \int Δ {a}_{2}^{BFS} dt & [ 163 ]\end{matrix}$$

Which allows rewriting expression [161] and [162] as:

$$\begin{matrix}\frac{1}{2} κ {p}_{0} δ {Sb}_{w} ( {M}_{0}^{2} {F}_{1} {f}^{1} + {F}_{2} {f}^{2} + {F}_{3} {f}^{3} + {M}_{0} {F}_{4} {f}^{4} + {F}_{5} {f}^{5} + {F}_{6} {f}^{6} + {F}_{7} {f}^{7} + {F}_{8} {f}^{8} + {F}_{9} {f}^{9} + {F}_{10} {f}^{10} + {F}_{11} {f}^{11} ) = {I}_{xx} ( m ) p - {I}_{xz} ( m ) r + {m}_{0} {F}_{12} {f}^{12} + A & [ 164 ] \\ \frac{1}{2} κ {p}_{0} δ {Sb}_{w} ( {M}_{0}^{2} {G}_{1} {f}^{1} + {G}_{2} {f}^{2} + {G}_{3} {f}^{3} + {M}_{0} {G}_{4} {f}^{4} + {G}_{5} {f}^{5} + {G}_{6} {f}^{6} + {G}_{7} {f}^{7} + {G}_{8} {f}^{8} + {G}_{9} {f}^{9} + {G}_{10} {f}^{10} + {G}_{11} {f}^{11} ) = - {I}_{xz} ( m ) p + {I}_{zz} ( m ) r + {m}_{0} {G}_{12} {f}^{12} + C & [ 165 ]\end{matrix}$$

where {A,C} are integration constants.

Expressions [164] and [165] constitute a linear observer for the unknowns {F₁, . . . , F₁₂, A, G₁, . . . , G₁₂, C} and {Iₓₓ(m), I_{xz} (m), I_{zz}(m)} valid for any Mach and actual mass. Thus by performing both experiments (i.e. the ailerons and rudder doublets) for different cases of Mach at the trim condition and actual mass, an overdetermined linear observation system is obtained that allows estimating the mentioned unknowns. In effect, if it is considered a case for the identification of {Iₓₓ(m),I_{xz}(m),I_{zz}(m)} for the combination {mᵢ,Mⱼ}, i.e., at the trim condition at Mach Mⱼ (j=1, . . . , lᵢ) with actual mass mᵢ (i=1, . . . , k) through aileron perturbation (expression [164]). For each case of Mⱼ, nⱼ samples of the response to a lateral perturbation are recorded. Thus:

$$\begin{matrix}{H}_{ij} = [ \begin{matrix}- \frac{{p}_{j 1}}{\frac{1}{2} κ {p}_{0} δ {Sb}_{w}} & \frac{{r}_{j 1}}{\frac{1}{2} κ {p}_{0} δ {Sb}_{w}} & 0 & {M}_{j}^{2} {f}_{j 1}^{1} & {f}_{j 1}^{2} & {f}_{j 1}^{3} & {M}_{j} {f}_{j 1}^{4} & {f}_{j 1}^{5} & {f}_{j 1}^{6} & {f}_{j 1}^{7} & {f}_{j 1}^{8} & {f}_{j 1}^{9} & {f}_{j 1}^{10} & {f}_{j 1}^{11} & - \frac{{m}_{i} {f}_{j 1}^{12}}{\frac{1}{2} κ {p}_{0} δ {Sb}_{w}} & - \frac{1}{\frac{1}{2} κ {p}_{0} δ {Sb}_{w}} & 0 \\ - \frac{{p}_{j 2}}{\frac{1}{2} κ {p}_{0} δ {Sb}_{w}} & \frac{{r}_{j 2}}{\frac{1}{2} κ {p}_{0} δ {Sb}_{w}} & 0 & {M}_{j}^{2} {f}_{j 2}^{1} & {f}_{j 2}^{2} & {f}_{j 2}^{3} & {M}_{j} {f}_{j 2}^{4} & {f}_{j 2}^{5} & {f}_{j 2}^{6} & {f}_{j 2}^{7} & {f}_{j 2}^{8} & {f}_{j 2}^{9} & {f}_{j 2}^{10} & {f}_{j 2}^{11} & - \frac{{m}_{i} {f}_{j 2}^{12}}{\frac{1}{2} κ {p}_{0} δ {Sb}_{w}} & - \frac{1}{\frac{1}{2} κ {p}_{0} δ {Sb}_{w}} & 0 \\ ⋮ & ⋮ & ⋮ & ⋮ & ⋮ & ⋮ & ⋮ & ⋮ & ⋮ & ⋮ & ⋮ & ⋮ & ⋮ & ⋮ & ⋮ & ⋮ & ⋮ \\ - \frac{{p}_{j {n}_{j}}}{\frac{1}{2} κ {p}_{0} δ {Sb}_{w}} & \frac{{r}_{j {n}_{j}}}{\frac{1}{2} κ {p}_{0} δ {Sb}_{w}} & 0 & {M}_{j}^{2} {f}_{j {n}_{j}}^{1} & {f}_{j {n}_{j}}^{2} & {f}_{j {n}_{j}}^{3} & {M}_{j} {f}_{j {n}_{j}}^{4} & {f}_{j {n}_{j}}^{5} & {f}_{j {n}_{j}}^{6} & {f}_{j {n}_{j}}^{7} & {f}_{j {n}_{j}}^{8} & {f}_{j {n}_{j}}^{9} & {f}_{j {n}_{j}}^{10} & {f}_{j {n}_{j}}^{11} & - \frac{{m}_{i} {f}_{j {n}_{j}}^{12}}{\frac{1}{2} κ {p}_{0} δ {Sb}_{w}} & - \frac{1}{\frac{1}{2} κ {p}_{0} δ {Sb}_{w}} & 0\end{matrix} ] & [ 166 ] \\ {z}_{ij} = [ \begin{matrix}{I}_{xx} ( {m}_{i} ) \\ {I}_{xz} ( {m}_{i} ) \\ {I}_{zz} ( {m}_{i} ) \\ {F}_{1} ( {α}_{ij} , {M}_{ij} , {ɛ}_{h , ij} ) \\ {F}_{2} ( {α}_{ij} , {M}_{ij} , {ɛ}_{h , ij} ) \\ {F}_{3} ( {α}_{ij} , {M}_{ij} , {ɛ}_{h , ij} ) \\ {F}_{4} ( {α}_{ij} , {M}_{ij} , {ɛ}_{h , ij} ) \\ {F}_{5} ( {α}_{ij} , {M}_{ij} , {ɛ}_{h , ij} ) \\ {F}_{7} ( {α}_{ij} , {M}_{ij} , {ɛ}_{h , ij} ) \\ {F}_{8} ( {α}_{ij} , {M}_{ij} , {ɛ}_{h , ij} ) \\ {F}_{9} ( {α}_{ij} , {M}_{ij} , {ɛ}_{h , ij} ) \\ {F}_{10} ( {α}_{ij} , {M}_{ij} , {ɛ}_{h , ij} ) \\ {F}_{11} ( {α}_{ij} , {M}_{ij} , {ɛ}_{h , ij} ) \\ {F}_{12} ( {α}_{ij} , {M}_{ij} , {ɛ}_{h , ij} ) \\ {A}_{ij} \\ {B}_{ij}\end{matrix} ] & [ 167 ] \\ {O}_{ij} = [ \begin{matrix}0 \\ 0 \\ ⋮ \\ 0\end{matrix} ] & [ 168 ] \\ {F}_{ij} = [ \begin{matrix}{M}_{j}^{2} {f}_{j 1}^{1} & {f}_{j 1}^{2} & {f}_{j 1}^{3} & {M}_{j} {f}_{j 1}^{4} & {f}_{j 1}^{5} & {f}_{j 1}^{6} & {f}_{j 1}^{7} & {f}_{j 1}^{8} & {f}_{j 1}^{9} & {f}_{j 1}^{10} & {f}_{j 1}^{11} & - \frac{{m}_{i} {f}_{j 1}^{12}}{\frac{1}{2} κ {p}_{0} δ {Sb}_{w}} & - \frac{1}{\frac{1}{2} κ {p}_{0} δ {Sb}_{w}} & 0 \\ {M}_{j}^{2} {f}_{j 2}^{1} & {f}_{j 2}^{2} & {f}_{j 2}^{3} & {M}_{j} {f}_{j 2}^{4} & {f}_{j 2}^{5} & {f}_{j 2}^{6} & {f}_{j 2}^{7} & {f}_{j 2}^{8} & {f}_{j 2}^{9} & {f}_{j 2}^{10} & {f}_{j 2}^{11} & - \frac{{m}_{i} {f}_{j 2}^{12}}{\frac{1}{2} κ {p}_{0} δ {Sb}_{w}} & - \frac{1}{\frac{1}{2} κ {p}_{0} δ {Sb}_{w}} & 0 \\ ⋮ & ⋮ & ⋮ & ⋮ & ⋮ & ⋮ & ⋮ & ⋮ & ⋮ & ⋮ & ⋮ & ⋮ & ⋮ & ⋮ \\ {M}_{j}^{2} {f}_{j {n}_{j}}^{1} & {f}_{j {n}_{j}}^{2} & {f}_{j {n}_{j}}^{3} & {M}_{j} {f}_{j {n}_{j}}^{4} & {f}_{j {n}_{j}}^{5} & {f}_{j {n}_{j}}^{6} & {f}_{j {n}_{j}}^{7} & {f}_{j {n}_{j}}^{8} & {f}_{j {n}_{j}}^{9} & {f}_{j {n}_{j}}^{10} & {f}_{j {n}_{j}}^{11} & - \frac{{m}_{i} {f}_{j {n}_{j}}^{12}}{\frac{1}{2} κ {p}_{0} δ {Sb}_{w}} & - \frac{1}{\frac{1}{2} κ {p}_{0} δ {Sb}_{w}} & 0\end{matrix} ] & [ 169 ] \\ {G}_{ij} = \frac{1}{\frac{1}{2} κ {p}_{0} δ {Sb}_{w}} [ \begin{matrix}- {p}_{j 1} & {r}_{j 1} & 0 \\ - {p}_{j 2} & {r}_{j 2} & 0 \\ ⋮ & ⋮ & ⋮ \\ - {p}_{{jn}_{j}} & {r}_{{jn}_{j}} & 0\end{matrix} ] & [ 170 ] \\ {C}_{R , ij} = [ \begin{matrix}{F}_{1} ( {α}_{ij} , {M}_{ij} , {ɛ}_{h , ij} ) \\ {F}_{2} ( {α}_{ij} , {M}_{ij} , {ɛ}_{h , ij} ) \\ {F}_{3} ( {α}_{ij} , {M}_{ij} , {ɛ}_{h , ij} ) \\ {F}_{4} ( {α}_{ij} , {M}_{ij} , {ɛ}_{h , ij} ) \\ {F}_{5} ( {α}_{ij} , {M}_{ij} , {ɛ}_{h , ij} ) \\ {F}_{7} ( {α}_{ij} , {M}_{ij} , {ɛ}_{h , ij} ) \\ {F}_{8} ( {α}_{ij} , {M}_{ij} , {ɛ}_{h , ij} ) \\ {F}_{9} ( {α}_{ij} , {M}_{ij} , {ɛ}_{h , ij} ) \\ {F}_{10} ( {α}_{ij} , {M}_{ij} , {ɛ}_{h , ij} ) \\ {F}_{11} ( {α}_{ij} , {M}_{ij} , {ɛ}_{h , ij} ) \\ {F}_{12} ( {α}_{ij} , {M}_{ij} , {ɛ}_{h , ij} ) \\ {A}_{ij} \\ {B}_{ij}\end{matrix} ] & [ 171 ]\end{matrix}$$

It is considered the same case for the identification of {Iₓₓ(m),I_{xz}(m),I_{zz}(m)} for the combination {mᵢ,Mⱼ}, i.e., at the trim condition at Mach Mⱼ (j=1, . . . , lᵢ) with actual mass mᵢ (i=1, . . . , k) through ruder perturbation (expression [165]). For each case of samples of the response to a lateral perturbation are recorded. Thus:

$$\begin{matrix}{H}_{ij} = [ \begin{matrix}0 & \frac{{p}_{j 1}}{\frac{1}{2} κ {p}_{0} δ {Sb}_{w}} & - \frac{{r}_{j 1}}{\frac{1}{2} κ {p}_{0} δ {Sb}_{w}} & {M}_{j}^{2} {f}_{j 1}^{1} & {f}_{j 1}^{2} & {f}_{j 1}^{3} & {M}_{j} {f}_{j 1}^{4} & {f}_{j 1}^{5} & {f}_{j 1}^{6} & {f}_{j 1}^{7} & {f}_{j 1}^{8} & {f}_{j 1}^{9} & {f}_{j 1}^{10} & {f}_{j 1}^{11} & - \frac{{m}_{i} {f}_{j 1}^{12}}{\frac{1}{2} κ {p}_{0} δ {Sb}_{w}} & 0 & - \frac{1}{\frac{1}{2} κ {p}_{0} δ {Sb}_{w}} \\ 0 & \frac{{p}_{j 2}}{\frac{1}{2} κ {p}_{0} δ {Sb}_{w}} & - \frac{{r}_{j 2}}{\frac{1}{2} κ {p}_{0} δ {Sb}_{w}} & {M}_{j}^{2} {f}_{j 2}^{1} & {f}_{j 2}^{2} & {f}_{j 2}^{3} & {M}_{j} {f}_{j 2}^{4} & {f}_{j 2}^{5} & {f}_{j 2}^{6} & {f}_{j 2}^{7} & {f}_{j 2}^{8} & {f}_{j 2}^{9} & {f}_{j 2}^{10} & {f}_{j 2}^{11} & - \frac{{m}_{i} {f}_{j 2}^{12}}{\frac{1}{2} κ {p}_{0} δ {Sb}_{w}} & 0 & - \frac{1}{\frac{1}{2} κ {p}_{0} δ {Sb}_{w}} \\ ⋮ & ⋮ & ⋮ & ⋮ & ⋮ & ⋮ & ⋮ & ⋮ & ⋮ & ⋮ & ⋮ & ⋮ & ⋮ & ⋮ & ⋮ & ⋮ & ⋮ \\ 0 & \frac{{p}_{j {h}_{j}}}{\frac{1}{2} κ {p}_{0} δ {Sb}_{w}} & - \frac{{r}_{j {h}_{j}}}{\frac{1}{2} κ {p}_{0} δ {Sb}_{w}} & {M}_{j}^{2} {f}_{j {h}_{j}}^{1} & {f}_{j {h}_{j}}^{2} & {f}_{j {h}_{j}}^{3} & {M}_{j} {f}_{j {h}_{j}}^{4} & {f}_{j {h}_{j}}^{5} & {f}_{j {h}_{j}}^{6} & {f}_{j {h}_{j}}^{7} & {f}_{j {h}_{j}}^{8} & {f}_{j {h}_{j}}^{9} & {f}_{j {h}_{j}}^{10} & {f}_{j {h}_{j}}^{11} & - \frac{{m}_{i} {f}_{j {h}_{j}}^{12}}{\frac{1}{2} κ {p}_{0} δ {Sb}_{w}} & 0 & - \frac{1}{\frac{1}{2} κ {p}_{0} δ {Sb}_{w}}\end{matrix} ] & [ 172 ] \\ {z}_{ij} = [ \begin{matrix}{I}_{xx} ( {m}_{i} ) \\ {I}_{xz} ( {m}_{i} ) \\ {I}_{zz} ( {m}_{i} ) \\ {G}_{1} ( {α}_{ij} , {M}_{ij} , {ɛ}_{h , ij} ) \\ {G}_{2} ( {α}_{ij} , {M}_{ij} , {ɛ}_{h , ij} ) \\ {G}_{3} ( {α}_{ij} , {M}_{ij} , {ɛ}_{h , ij} ) \\ {G}_{4} ( {α}_{ij} , {M}_{ij} , {ɛ}_{h , ij} ) \\ {G}_{5} ( {α}_{ij} , {M}_{ij} , {ɛ}_{h , ij} ) \\ {G}_{6} ( {α}_{ij} , {M}_{ij} , {ɛ}_{h , ij} ) \\ {G}_{7} ( {α}_{ij} , {M}_{ij} , {ɛ}_{h , ij} ) \\ {G}_{8} ( {α}_{ij} , {M}_{ij} , {ɛ}_{h , ij} ) \\ {G}_{9} ( {α}_{ij} , {M}_{ij} , {ɛ}_{h , ij} ) \\ {G}_{10} ( {α}_{ij} , {M}_{ij} , {ɛ}_{h , ij} ) \\ {G}_{11} ( {α}_{ij} , {M}_{ij} , {ɛ}_{h , ij} ) \\ {G}_{12} ( {α}_{ij} , {M}_{ij} , {ɛ}_{h , ij} ) \\ {A}_{ij} \\ {B}_{ij}\end{matrix} ] & [ 173 ] \\ {O}_{ij} = [ \begin{matrix}0 \\ 0 \\ ⋮ \\ 0\end{matrix} ] & [ 174 ] \\ {J}_{ij} = [ \begin{matrix}{M}_{j}^{2} {f}_{j 1}^{1} & {f}_{j 1}^{2} & {f}_{j 1}^{3} & {M}_{j} {f}_{j 1}^{4} & {f}_{j 1}^{5} & {f}_{j 1}^{6} & {f}_{j 1}^{7} & {f}_{j 1}^{8} & {f}_{j 1}^{9} & {f}_{j 1}^{10} & {f}_{j 1}^{11} & - \frac{{m}_{i} {f}_{j 1}^{12}}{\frac{1}{2} κ {p}_{0} δ {Sb}_{w}} & 0 & - \frac{1}{\frac{1}{2} κ {p}_{0} δ {Sb}_{w}} \\ {M}_{j}^{2} {f}_{j 2}^{1} & {f}_{j 2}^{2} & {f}_{j 2}^{3} & {M}_{j} {f}_{j 2}^{4} & {f}_{j 2}^{5} & {f}_{j 2}^{6} & {f}_{j 2}^{7} & {f}_{j 2}^{8} & {f}_{j 2}^{9} & {f}_{j 2}^{10} & {f}_{j 2}^{11} & - \frac{{m}_{i} {f}_{j 2}^{12}}{\frac{1}{2} κ {p}_{0} δ {Sb}_{w}} & 0 & - \frac{1}{\frac{1}{2} κ {p}_{0} δ {Sb}_{w}} \\ ⋮ & ⋮ & ⋮ & ⋮ & ⋮ & ⋮ & ⋮ & ⋮ & ⋮ & ⋮ & ⋮ & ⋮ & ⋮ & ⋮ \\ {M}_{j}^{2} {f}_{j {h}_{j}}^{1} & {f}_{j {h}_{j}}^{2} & {f}_{j {h}_{j}}^{3} & {M}_{j} {f}_{j {h}_{j}}^{4} & {f}_{j {h}_{j}}^{5} & {f}_{j {h}_{j}}^{6} & {f}_{j {h}_{j}}^{7} & {f}_{j {h}_{j}}^{8} & {f}_{j {h}_{j}}^{9} & {f}_{j {h}_{j}}^{10} & {f}_{j {h}_{j}}^{11} & - \frac{{m}_{i} {f}_{j {h}_{j}}^{12}}{\frac{1}{2} κ {p}_{0} δ {Sb}_{w}} & 0 & - \frac{1}{\frac{1}{2} κ {p}_{0} δ {Sb}_{w}}\end{matrix} ] & [ 175 ] \\ {K}_{ij} = \frac{1}{\frac{1}{2} κ {p}_{0} δ {Sb}_{w}} [ \begin{matrix}0 & {p}_{j 1} & - {r}_{j 1} \\ 0 & {p}_{j 2} & - {r}_{j 2} \\ ⋮ & ⋮ & ⋮ \\ 0 & {p}_{j {h}_{j}} & - {r}_{j {h}_{j}}\end{matrix} ] & [ 176 ] \\ {C}_{Y , ij} = [ \begin{matrix}{G}_{1} ( {α}_{ij} , {M}_{ij} , {ɛ}_{h , ij} ) \\ {G}_{2} ( {α}_{ij} , {M}_{ij} , {ɛ}_{h , ij} ) \\ {G}_{3} ( {α}_{ij} , {M}_{ij} , {ɛ}_{h , ij} ) \\ {G}_{4} ( {α}_{ij} , {M}_{ij} , {ɛ}_{h , ij} ) \\ {G}_{5} ( {α}_{ij} , {M}_{ij} , {ɛ}_{h , ij} ) \\ {G}_{6} ( {α}_{ij} , {M}_{ij} , {ɛ}_{h , ij} ) \\ {G}_{7} ( {α}_{ij} , {M}_{ij} , {ɛ}_{h , ij} ) \\ {G}_{8} ( {α}_{ij} , {M}_{ij} , {ɛ}_{h , ij} ) \\ {G}_{9} ( {α}_{ij} , {M}_{ij} , {ɛ}_{h , ij} ) \\ {G}_{10} ( {α}_{ij} , {M}_{ij} , {ɛ}_{h , ij} ) \\ {G}_{11} ( {α}_{ij} , {M}_{ij} , {ɛ}_{h , ij} ) \\ {G}_{12} ( {α}_{ij} , {M}_{ij} , {ɛ}_{h , ij} ) \\ {A}_{ij} \\ {B}_{ij}\end{matrix} ] & [ 177 ] \\ {H}_{i} = [ \begin{matrix}{G}_{i 1} & {F}_{i 1} & 0 & … & 0 & 0 & 0 & … & 0 \\ {G}_{i 2} & 0 & {F}_{i 2} & … & 0 & 0 & 0 & … & 0 \\ ⋮ & ⋮ & ⋮ & & ⋮ & ⋮ & ⋮ & & ⋮ \\ {G}_{{il}_{i}} & 0 & 0 & … & {F}_{{il}_{i}} & 0 & 0 & … & 0 \\ {K}_{i 1} & 0 & 0 & … & 0 & {J}_{i 1} & 0 & … & 0 \\ {K}_{i 2} & 0 & 0 & … & 0 & 0 & {J}_{i 2} & … & 0 \\ ⋮ & ⋮ & ⋮ & & ⋮ & ⋮ & ⋮ & & ⋮ \\ {K}_{{il}_{i}} & 0 & 0 & … & 0 & 0 & 0 & … & {J}_{{il}_{i}}\end{matrix} ] dim ( {H}_{i} ) = ( {\sum }_{j = 1}^{{l}_{i}} {n}_{j} + {\sum }_{j = 1}^{{l}_{i}} {h}_{j} ) \times ( 3 + 14 {l}_{i} ) & [ 178 ] \\ {z}_{i} = [ \begin{matrix}{I}_{xx} ( {m}_{i} ) \\ {I}_{xz} ( {m}_{i} ) \\ {I}_{zz} ( {m}_{i} ) \\ {C}_{R , i 1} \\ {C}_{R , i 2} \\ ⋮ \\ {C}_{R , i {l}_{i}} \\ {C}_{Y , i 1} \\ {C}_{Y , i 2} \\ ⋮ \\ {C}_{Y , i {l}_{i}}\end{matrix} ] dim ( {z}_{i} ) = ( 3 + 14 {l}_{i} ) \times 1 & [ 179 ] \\ {O}_{i} = [ \begin{matrix}0 \\ 0 \\ ⋮ \\ 0\end{matrix} ] dim ( {O}_{i} ) = ( {\sum }_{j = 1}^{{l}_{i}} {n}_{j} + {\sum }_{j = 1}^{{l}_{i}} {h}_{j} ) \times 1 & [ 180 ] \\ {z}_{i} = {( {H}_{i}^{T} {H}_{i} )}^{- 1} {H}_{i}^{T} {O}_{i} & [ 181 ] \\ {I}_{xx} ( {m}_{i} ) = {z}_{i} [ 1 ] & [ 182 ] \\ {I}_{xz} ( {m}_{i} ) = {z}_{i} [ 2 ] & [ 183 ] \\ {I}_{zz} ( {m}_{i} ) = {z}_{i} [ 3 ] & [ 184 ]\end{matrix}$$

Repeating the process for different values of the actual mass would render the variation of {Iₓₓ(m),I_{xz}(m),I_{zz}(m)} with m for i=1, . . . , k

Now, referring back to the balance condition governed by expressions [73], [118] and [119] for the identification cases considered:

$$\frac{1}{2} κ {p}_{0} δ {M}_{ij}^{2} {Sb}_{w} {C}_{R , 0} ( {α}_{ij} , {M}_{ij} , {ɛ}_{h , ij} ) = - {T}_{ij} {E}_{1} - {M}_{T , ij} = - {T}_{ij} {E}_{1} - {m}_{MTOW} {b}_{w}^{2} {N}_{s , ij}^{2} {C}_{{M}_{T}}$$

$$\frac{1}{2} κ {p}_{0} δ {M}_{ij}^{2} {Sc}_{w} {C}_{P , 0} ( {α}_{ij} , {M}_{ij} , {ɛ}_{h , ij} ) = - {T}_{ij} {E}_{2} + {M}_{T , ij} υ = - {T}_{ij} {E}_{2} + {m}_{MTOW} {b}_{w}^{2} {N}_{s , ij}^{2} {C}_{{M}_{T}} υ$$

$$\frac{1}{2} κ {p}_{0} δ {M}_{ij}^{2} {Sb}_{w} {C}_{Y , 0} ( {α}_{ij} , {M}_{ij} , {ɛ}_{h , ij} ) = - {T}_{ij} {E}_{3} + {M}_{T , ij} ɛ = - {T}_{ij} {E}_{3} + {m}_{MTOW} {b}_{w}^{2} {N}_{s , ij}^{2} {C}_{{M}_{T}} ɛ \\$$

with Tᵢⱼ for the different flight conditions given by the thrust model already known and M_{T} given by expression [64].

Expressions [185], [186] and [187] contain 4 more unknowns than equations. To reduce the system encompassed by [185], [186] and [187] to an overdetermined system, it is introduced a Taylor expansion for C_{R,0}, C_{p,0} and C_{Y,0} in the form (approximations of higher orders could be employed, if necessary):

C_{R,0}(αᵢⱼ,Mᵢⱼ,ε_{h,ij})=r₀+r_{α1}αᵢⱼ+r_{M1}Mᵢⱼ+r_{ε}_{ₕ}₁ε_{h,ij} [188]

C_{P,0}(αᵢⱼ,Mᵢⱼ,ε_{h,ij})=p₀+p_{α1}αᵢⱼ+p_{M1}Mᵢⱼ+p_{ε}_{ₕ}₁ε_{h,ij} [189]

C_{Y,0}(αᵢⱼ,Mᵢⱼ,ε_{h,ij})=y₀+y_{α1}αᵢⱼ+y_{M1}Mᵢⱼ+y_{ε}_{ₕ}₁ε_{h,ij} [190]

which renders the following linear observation system for {r₀, r_{α1}, r_{M1}, r_{ε}_{ₕ}₁, p₀, p_{α1}, p_{M1}, p_{ε}_{ₕ}₁, y₀, y_{α1}, y_{M1}, y_{ε}_{ₕ}₁)} and {E₁, E₂, E₃, C_{M}_{_{T}}}:

$${H}_{i} = [ \begin{matrix}\frac{{T}_{i 1}}{\begin{matrix}\frac{1}{2} \\ κ {p}_{0} δ {Sb}_{w}\end{matrix}} & 0 & 0 & \frac{\begin{matrix}{m}_{MTOW} \\ {b}_{w}^{2} {N}_{s , i 1}^{2}\end{matrix}}{\frac{1}{2} κ {p}_{0} δ {Sc}_{w}} & {M}_{i 1}^{2} & {M}_{i 1}^{2} {α}_{i 1} & {M}_{i 1}^{3} & {M}_{i 1}^{2} {ɛ}_{h , i 1} & 0 & 0 & 0 & 0 & 0 & 0 & 0 & 0 \\ \frac{{T}_{i 2}}{\begin{matrix}\frac{1}{2} \\ κ {p}_{0} δ {Sb}_{w}\end{matrix}} & 0 & 0 & \frac{\begin{matrix}{m}_{MTOW} \\ {b}_{w}^{2} {N}_{s , i 2}^{2}\end{matrix}}{\frac{1}{2} κ {p}_{0} δ {Sc}_{w}} & {M}_{i 2}^{2} & {M}_{i 2}^{2} {α}_{i 2} & {M}_{i 2}^{3} & {M}_{i 2}^{2} {ɛ}_{h , i 2} & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ & ⋮ & ⋮ & ⋮ & ⋮ & ⋮ & ⋮ \\ \frac{{T}_{{il}_{i}}}{\begin{matrix}\frac{1}{2} \\ κ {p}_{0} δ {Sb}_{w}\end{matrix}} & 0 & 0 & \frac{\begin{matrix}{m}_{MTOW} \\ {b}_{w}^{2} {N}_{s , {il}_{i}}^{2}\end{matrix}}{\frac{1}{2} κ {p}_{0} δ {Sc}_{w}} & {M}_{{il}_{i}}^{2} & {M}_{{il}_{i}}^{2} {α}_{{il}_{i}} & {M}_{{il}_{i}}^{3} & {M}_{{il}_{i}}^{2} {ɛ}_{h , {il}_{i}} & 0 & 0 & 0 & 0 & 0 & 0 & 0 & 0 \\ 0 & \frac{{T}_{i 1}}{\begin{matrix}\frac{1}{2} \\ κ {p}_{0} δ {Sb}_{w}\end{matrix}} & 0 & - \frac{\begin{matrix}{m}_{MTOW} \\ {b}_{w}^{2} {N}_{s , i 1}^{2} υ\end{matrix}}{\frac{1}{2} κ {p}_{0} δ {Sc}_{w}} & 0 & 0 & 0 & 0 & {M}_{i 1}^{2} & {M}_{i 1}^{2} {α}_{i 1} & {M}_{i 1}^{3} & {M}_{i 1}^{2} {ɛ}_{h , i 1} & 0 & 0 & 0 & 0 \\ 0 & \frac{{T}_{i 2}}{\begin{matrix}\frac{1}{2} \\ κ {p}_{0} δ {Sb}_{w}\end{matrix}} & 0 & - \frac{\begin{matrix}{m}_{MTOW} \\ {b}_{w}^{2} {N}_{s , i 2}^{2} υ\end{matrix}}{\frac{1}{2} κ {p}_{0} δ {Sc}_{w}} & 0 & 0 & 0 & 0 & {M}_{i 2}^{2} & {M}_{i 2}^{2} {α}_{i 2} & {M}_{i 2}^{3} & {M}_{i 2}^{2} {ɛ}_{h , i 2} & 0 & 0 & 0 & 0 \\ ⋮ & ⋮ & ⋮ & ⋮ & ⋮ & ⋮ & ⋮ & ⋮ & ⋮ & ⋮ & ⋮ & ⋮ & ⋮ & ⋮ & ⋮ & ⋮ \\ 0 & \frac{{T}_{{il}_{i}}}{\begin{matrix}\frac{1}{2} \\ κ {p}_{0} δ {Sb}_{w}\end{matrix}} & 0 & - \frac{\begin{matrix}{m}_{MTOW} \\ {b}_{w}^{2} {N}_{s , {il}_{i}}^{2} υ\end{matrix}}{\frac{1}{2} κ {p}_{0} δ {Sc}_{w}} & 0 & 0 & 0 & 0 & {M}_{{il}_{i}}^{2} & {M}_{{il}_{i}}^{2} {α}_{{il}_{i}} & {M}_{{il}_{i}}^{3} & {M}_{{il}_{i}}^{2} {ɛ}_{h , {il}_{i}} & 0 & 0 & 0 & 0 \\ 0 & 0 & \frac{{T}_{i 1}}{\begin{matrix}\frac{1}{2} \\ κ {p}_{0} δ {Sb}_{w}\end{matrix}} & - \frac{\begin{matrix}{m}_{MTOW} \\ {b}_{w}^{2} {N}_{s , i 1}^{2} ɛ\end{matrix}}{\frac{1}{2} κ {p}_{0} δ {Sc}_{w}} & 0 & 0 & 0 & 0 & 0 & 0 & 0 & 0 & {M}_{i 1}^{2} & {M}_{i 1}^{2} {α}_{i 1} & {M}_{i 1}^{3} & {M}_{i 1}^{2} {ɛ}_{h , i 1} \\ 0 & 0 & \frac{{T}_{i 1}}{\begin{matrix}\frac{1}{2} \\ κ {p}_{0} δ {Sb}_{w}\end{matrix}} & - \frac{\begin{matrix}{m}_{MTOW} \\ {b}_{w}^{2} {N}_{s , i 2}^{2} ɛ\end{matrix}}{\frac{1}{2} κ {p}_{0} δ {Sc}_{w}} & 0 & 0 & 0 & 0 & 0 & 0 & 0 & 0 & {M}_{i 2}^{2} & {M}_{i 2}^{2} {α}_{i 2} & {M}_{i 2}^{3} & {M}_{i 2}^{2} {ɛ}_{h , i 2} \\ ⋮ & ⋮ & ⋮ & ⋮ & ⋮ & ⋮ & ⋮ & ⋮ & ⋮ & ⋮ & ⋮ & ⋮ & ⋮ & ⋮ & ⋮ & ⋮ \\ 0 & 0 & \frac{{T}_{{il}_{i}}}{\begin{matrix}\frac{1}{2} \\ κ {p}_{0} δ {Sb}_{w}\end{matrix}} & - \frac{\begin{matrix}{m}_{MTOW} \\ {b}_{w}^{2} {N}_{s , {il}_{i}}^{2} ɛ\end{matrix}}{\frac{1}{2} κ {p}_{0} δ {Sc}_{w}} & 0 & 0 & 0 & 0 & 0 & 0 & 0 & 0 & {M}_{{il}_{i}}^{2} & {M}_{{il}_{i}}^{2} {α}_{{il}_{i}} & {M}_{{il}_{i}}^{3} & {M}_{{il}_{i}}^{2} {ɛ}_{h , {il}_{i}}\end{matrix} ] \\ z = [ \begin{matrix}{E}_{1} \\ {E}_{2} \\ {E}_{3} \\ {C}_{{M}_{T}} \\ {r}_{0} \\ {r}_{α1} \\ {r}_{M 1} \\ {r}_{{ɛ}_{h} 1} \\ {p}_{0} \\ {p}_{α1} \\ {p}_{M 1} \\ {p}_{{ɛ}_{h} 1} \\ {y}_{0} \\ {y}_{α1} \\ {y}_{M 1} \\ {y}_{{ɛ}_{h} 1}\end{matrix} ] dim ( z ) = 16 \times 1 \\ {O}_{i} = [ \begin{matrix}0 \\ 0 \\ ⋮ \\ 0\end{matrix} ] dim ( {O}_{i} ) = 3 {l}_{i} \times 1 \\ H = [ \begin{matrix}{H}_{1} \\ {H}_{2} \\ ⋮ \\ {H}_{k}\end{matrix} ] dim ( H ) = 3 {kl}_{i} \times 16 \\ O = [ \begin{matrix}{O}_{1} \\ {O}_{2} \\ ⋮ \\ {O}_{k}\end{matrix} ] dim ( O ) = 3 {kl}_{i} \times 1 \\ z = {( {H}^{T} H )}^{- 1} {H}^{T} O \\ {E}_{1} = z [ 1 ] \\ {E}_{2} = z [ 2 ] \\ {E}_{3} = z [ 3 ] \\ {C}_{{M}_{T}} = z [ 4 ]$$

### Step 250 for Determination of the Aerodynamic Moments Model

Once the parameters of the propulsive models have been identified, expression [53] can be used again, this time as a direct observer for the aerodynamic moment coefficients as follows:

$$\begin{matrix}[ \begin{matrix}\frac{1}{2} κ {p}_{0} δ {M}^{2} {Sb}_{w} {C}_{R} \\ \frac{1}{2} κ {p}_{0} δ {M}^{2} {Sc}_{w} {C}_{P} \\ \frac{1}{2} κ {p}_{0} δ {M}^{2} {Sb}_{w} {C}_{Y}\end{matrix} ] = [ \begin{matrix}{I}_{xx} & 0 & - {I}_{xz} \\ 0 & {I}_{yy} & 0 \\ - {I}_{xz} & 0 & {I}_{zz}\end{matrix} ] [ \begin{matrix}\dot{p} - {D}_{9} pq + {D}_{10} qr \\ \dot{q} + {D}_{11} ( {p}^{2} - {r}^{2} ) + {D}_{12} pr \\ \dot{r} - {D}_{13} pq + {D}_{14} qr\end{matrix} ] - [ \begin{matrix}{R}_{P} \\ {P}_{P} \\ {Y}_{P}\end{matrix} ] & [ 201 ] \\ [ \begin{matrix}{R}_{P} \\ {P}_{P} \\ {Y}_{P}\end{matrix} ] = T [ \begin{matrix}{E}_{1} \\ {E}_{2} \\ {E}_{3}\end{matrix} ] + {M}_{T} [ \begin{matrix}1 \\ - υ \\ - ɛ\end{matrix} ] & [ 202 ]\end{matrix}$$

Expression [201] allows the estimation of the aerodynamic moment coefficients C_{R}, C_{P} and C_{Y} in terms of their dependency variables through flight testing, for which the respective domains have to be swept, which can be done manually and or with the help of control loops such as AOS-on-rudder, bank-on-ailerons and q-on-elevator.

In the general case:

C_{R}=C_{R}(α,β,M,\dot{\hat{α}},\dot{\hat{β}},\hat{p},\hat{q},\hat{r},εₕ,εₐ,εᵣ,εₑ) [203]

C_{P}=C_{P}(α,β,M,\dot{\hat{α}},\dot{\hat{β}},\hat{p},\hat{q},\hat{r},εₕ,εₐ,εᵣ,εₑ) [204]

C_{Y}=C_{Y}(α,β,M,\dot{\hat{α}},\dot{\hat{β}},\hat{p},\hat{q},\hat{r},εₕ,εₐ,εᵣ,εₑ) [205]

Typical symmetry assumptions render:

C_{R}=C_{R}(α,β,M,\dot{\hat{α}},\dot{\hat{β}},\hat{p},\hat{r},εₐ,εᵣ) [206]

C_{P}=C_{P}(α,β,M,\dot{\hat{α}},\dot{\hat{β}},\hat{q},εₕ,εₑ,εᵣ) [207]

C_{Y}=C_{Y}(α,β,M,\dot{\hat{α}},\dot{\hat{β}},\hat{p},\hat{r},εₐ,εᵣ) [208]

Additionally, for uncompressible aerodynamics and small AOS the main dependencies of the aerodynamics coefficients under the quasi-steady state and typical symmetry assumptions remain:

C_{R}=C_{R}(β,\dot{\hat{β}},\hat{p},\hat{r},εₐ,εᵣ) [209]

C_{P}=C_{P}(α,\dot{\hat{α}},\hat{q},εₕ,εₑ,εᵣ) [210]

C_{Y}=C_{Y}(β,\dot{\hat{β}},\hat{p},\hat{r},εₐ,εᵣ) [211]

Finally, for quasi-steady flight:

C_{R}=C_{R}(β,\hat{p},\hat{r},εₐ,εᵣ) [212]

C_{P}=C_{P}(α,\hat{q},εₕ,εₑ,εᵣ) [213]

C_{Y}=C_{Y}(β,\hat{p},\hat{r},εₐ,εᵣ) [214]

For fixed-wing UAVs flying at moderate speeds, in quasi-steady coordinated flight, the aerodynamic model of interest is:

C_{L}=C_{L}(α,\hat{q},εₕ,εₑ) [215]

C_{Q}=C_{Q}(β,\hat{p},\hat{r},εₐ,εᵣ) [216]

C_{D}=C_{D}(α,\hat{q},εₕ,εₑ) [217]

C_{R}=C_{R}(β,\hat{p},\hat{r},εₐ,εᵣ) [218]

C_{P}=C_{P}(α,\hat{q},εₕ,εₑ,εᵣ) [219]

C_{Y}=C_{Y}(β,\hat{p},\hat{r},εₐ,εᵣ) [220]

The propulsive model is characterized by:

C_{T}(δ,θ,M,ε_{T}) [221]

{ε,υ} [222]

{E₁,E₂,E₃} [223]

C_{M}_{_{T}} [224]

The mass and inertia properties are characterized by:

C_{F}=C_{F}(δ,θ,ε_{T}) [225]

Iₓₓ=Iₓₓ(m) [226]

I_{yy}=I_{yy}(m) [227]

I_{zz}=I_{zz}(m) [228]

I_{xz}=I_{xz}(m) [229]

Based on the afore described approach, an automated flight test procedure may be implemented that obtains an APM with the help of several basic control loops:
AOS-on-rudder
Altitude-on-bank
Speed-on-elevator
AOA-on-elevator
Pitch rate-on-elevator

Once the propulsive forces and moments model are well identified, the aerodynamic model may be continuously identified while-on-the-flight, populating the respective n-dimensional hypercubes allocated to each aerodynamic coefficient (cell-mapping) continuously averaging the new value estimated for each cell with the previously existing one. To that end, an acceptable tradeoff between the range and discretization step of each dependency variable and available runtime memory must be achieved.

A measure of the goodness of the LS fit in every linear observation problem considered above can be obtained through the RMS (Root Mean Square) error:

$$\begin{matrix}e = Hz - O & [ 230 ] \\ SSE = {e}^{T} e Sum of Square Errors & [ 231 ] \\ RMS = \sqrt{\frac{SSE}{dim ( e )}} Root Mean Square & [ 232 ]\end{matrix}$$

### Linearization of the Equations of Motion (Linear Motion of the CoG)

### Linear Motion Equations in BFS:

$$[ \begin{matrix}L sin α + Q sin β cos α - D cos β cos α \\ - D sin β - Q cos β \\ - L cos α + Q sin β sin α - D cos β sin α\end{matrix} ] + T [ \begin{matrix}1 \\ - υ \\ - ɛ\end{matrix} ] = m [ \begin{matrix}{a}_{1}^{BFS} \\ {a}_{2}^{BFS} \\ {a}_{3}^{BFS}\end{matrix} ] \qquad [ 233 ]$$

Longitudinal Motion with AOS-On-Rudder to Ensure Coordinated Flight:

$$\dot{β} ≡ β ≡ 0$$

$$p ≡ r ≡ 0$$

$$L sin α - D cos α + T = {ma}_{1}^{BFS} \\ - L cos α - D sin α - T ɛ = {ma}_{3}^{BFS}$$

$$\frac{1}{2} κ {p}_{0} δ {M}^{2} S [ {C}_{L} sin α - {C}_{D} cos α ] + {W}_{MTOW} δ {C}_{T} = {ma}_{1}^{BFS} \\ - \frac{1}{2} κ {p}_{0} δ {M}^{2} S [ {C}_{L} cos α + {C}_{D} sin α ] - {W}_{MTOW} δ {C}_{T} ɛ = {ma}_{3}^{BFS}$$

Close enough to the balanced flight condition and, as long as E, is held null, εₐ and εᵣ are close to null and ε_{h,0} is held constant, the aerodynamic lift and drag coefficients can be approximated by the respective Taylor expansions in the form:

$$\begin{matrix}{C}_{L} ( α , 0 , M , \hat{\dot{α}} , 0 , 0 , \hat{q} , 0 , {ɛ}_{h , 0} , 0 , 0 , 0 ) = {C}_{L} ( α , M , \hat{\dot{α}} , \hat{q} ) = {C}_{L , 0} + {C}_{L , α} Δ α + {C}_{L , M} Δ M + {C}_{L , \hat{\dot{α}}} \hat{\dot{α}} + {C}_{L , \hat{q}} \hat{q} = {C}_{L , 0} + Δ {C}_{L} & [ 238 ] \\ {C}_{D} ( α , 0 , M , \hat{\dot{α}} , 0 , 0 , \hat{q} , 0 , {ɛ}_{h , 0} , 0 , 0 , 0 ) = {C}_{D} ( α , M , \hat{\dot{α}} , \hat{q} ) = {C}_{D , 0} + {C}_{D , α} Δ α + {C}_{D , M} Δ M + {C}_{D , \hat{\dot{α}}} \hat{\dot{α}} + {C}_{D , \hat{q}} \hat{q} = {C}_{D , 0} + Δ {C}_{D} & [ 239 ] \\ {C}_{L , \hat{\dot{α}}} \hat{\dot{α}} = {C}_{L , \hat{\dot{α}}} \frac{\dot{α} {c}_{w}}{2 {v}_{TAS}} = {C}_{L , \hat{\dot{α}}} \frac{{c}_{w}}{2 {a}_{0}} \frac{\dot{a}}{M} = {C}_{L , \dot{a}} \frac{\dot{a}}{M} \\ {C}_{L , \dot{α}} = {C}_{L , \hat{\dot{α}}} \frac{{c}_{w}}{2 {a}_{0}} & [ 240 ] \\ {C}_{L , \hat{q}} \hat{q} = {C}_{L , \hat{q}} \frac{{qc}_{w}}{2 {v}_{TAS}} = {C}_{L , \hat{q}} \frac{{c}_{w}}{2 {a}_{0}} \frac{q}{M} = {C}_{L , q} \frac{q}{M} \\ {C}_{L , q} = {C}_{L , \hat{q}} \frac{{c}_{w}}{2 {a}_{0}} & [ 241 ] \\ {C}_{D , \hat{\dot{α}}} \hat{\dot{α}} = {C}_{D , \hat{\dot{α}}} \frac{\dot{α} {c}_{w}}{2 {v}_{TAS}} = {C}_{D , \hat{\dot{α}}} \frac{{c}_{w}}{2 {a}_{0}} \frac{\dot{α}}{M} = {C}_{D , \dot{α}} \frac{\dot{α}}{M} \\ {C}_{D , \dot{α}} = {C}_{L , \hat{\dot{α}}} \frac{{c}_{w}}{2 {a}_{0}} & [ 242 ] \\ {C}_{D , \hat{q}} \hat{q} = {C}_{D , \hat{q}} \frac{{qc}_{w}}{2 {v}_{TAS}} = {C}_{D , \hat{q}} \frac{{c}_{w}}{2 {a}_{0}} \frac{q}{M} = {C}_{D , q} \frac{q}{M} \\ {C}_{D , q} = {C}_{D , \hat{q}} \frac{{c}_{w}}{2 {a}_{0}} & [ 243 ] \\ {C}_{L} ( α , M , \hat{\dot{α}} , \hat{q} ) = {C}_{L , 0} + {C}_{L , α} Δ α + {C}_{L , M} Δ M + {C}_{L , \dot{α}} \frac{\dot{α}}{M} + {C}_{L , q} \frac{q}{M} & [ 244 ] \\ {C}_{D} ( α , M , \hat{\dot{α}} , \hat{q} ) = {C}_{D , 0} + {C}_{D , α} Δ α + {C}_{D , M} Δ M + {C}_{D , \dot{α}} \frac{\dot{α}}{M} + {C}_{D , q} \frac{q}{M} & [ 245 ]\end{matrix}$$

As for the thrust coefficient, assuming level flight at the trim condition and the fact that the throttle level does not change:

C_{T}(δ,θ,M,ε_{T,0})=C_{T,0}(δ,θ,M₀,ε_{T,0})+C_{T,M}(δ,θ,M₀,ε_{T,0})ΔM [246]

At the balanced flight condition:

$$\frac{1}{2} κ {p}_{0} δ {M}_{0}^{2} S [ {C}_{L , 0} sin {α}_{0} - {C}_{D , 0} cos {α}_{0} ] + {W}_{MTOW} δ {C}_{T , 0} = {m}_{0} {a}_{1 , 0}^{BFS} \\ - \frac{1}{2} κ {p}_{0} δ {M}_{0}^{2} S [ {C}_{L , 0} cos {α}_{0} + {C}_{D , 0} sin {α}_{0} ] - {W}_{MTOW} δ {C}_{T , 0} ɛ = {m}_{0} {a}_{3 , 0}^{BFS}$$

And close enough to the balanced flight condition:

$$\frac{1}{2} κ {p}_{0} δ {M}^{2} S [ {C}_{L} sin α - {C}_{D} cos α ] + {W}_{MTOW} δ {C}_{T} = {m}_{0} ( {a}_{1 , 0}^{BFS} + Δ {a}_{1}^{BFS} ) - \frac{1}{2} κ {p}_{0} δ {M}^{2} S [ {C}_{L} cos α + {C}_{D} sin α ] - {W}_{MTOW} δ {C}_{T} ɛ = {m}_{0} ( {a}_{3 , 0}^{BFS} + Δ {a}_{3}^{BFS} )$$

$$Δ {a}_{1}^{BFS} = {a}_{1}^{BFS} - {a}_{1 , 0}^{BFS}$$

$$Δ {a}_{3}^{BFS} = {a}_{3}^{BFS} - {a}_{3 , 0}^{BFS}$$

$${C}_{L} sin ( {α}_{0} + Δα ) - {C}_{D} cos ( {α}_{0} + Δα ) = {C}_{L} ( sin {α}_{0} cos Δα + cos {α}_{0} sin Δα ) - {C}_{D} ( cos {α}_{0} cos Δα - sin {α}_{0} sin Δα )$$

$${C}_{L} cos ( {α}_{0} + Δα ) + {C}_{D} sin ( {α}_{0} + Δα ) = {C}_{L} ( cos {α}_{0} cos Δα - sin {α}_{0} sin Δα ) + {C}_{D} ( sin {α}_{0} cos Δα + cos {α}_{0} sin Δα )$$

$$Δα ≪ 1$$

$${C}_{L} sin ( {α}_{0} + Δα ) - {C}_{D} cos ( {α}_{0} + Δα ) \approx \approx {C}_{L} ( sin {α}_{0} + cos {α}_{0} Δα ) - {C}_{D} ( cos {α}_{0} - sin {α}_{0} Δα ) = {C}_{L} sin {α}_{0} - {C}_{D} cos {α}_{0} + ( {C}_{L} cos {α}_{0} + {C}_{D} sin {α}_{0} ) Δα$$

$${C}_{L} cos ( {α}_{0} + Δα ) + {C}_{D} sin ( {α}_{0} + Δα ) \approx {C}_{L} ( cos {α}_{0} - sin {α}_{0} Δα ) + {C}_{D} ( sin {α}_{0} + cos {α}_{0} Δα ) == {C}_{L} cos {α}_{0} + {C}_{D} sin {α}_{0} - ( {C}_{L} sin {α}_{0} - {C}_{D} cos {α}_{0} ) Δα$$

$${C}_{L} sin ( {α}_{0} + Δα ) - {C}_{D} cos ( {α}_{0} + Δα ) + {C}_{L} cos ( {α}_{0} + Δα ) + {C}_{D} sin ( {α}_{0} + Δα ) == {C}_{L} sin {α}_{0} - {C}_{D} cos {α}_{0} + ( {C}_{L} cos {α}_{0} + {C}_{D} sin {α}_{0} ) Δα + {C}_{L} cos {α}_{0} + {C}_{D} sin {α}_{0} - ( {C}_{L} sin {α}_{0} - {C}_{D} cos {α}_{0} ) Δα$$

$${C}_{L} sin ( {α}_{0} + Δα ) - {C}_{D} cos ( {α}_{0} + Δα ) - {C}_{L} cos ( {α}_{0} + Δα ) - {C}_{D} sin ( {α}_{0} + Δα ) == {C}_{L} sin {α}_{0} - {C}_{D} cos {α}_{0} + ( {C}_{L} cos {α}_{0} + {C}_{D} sin {α}_{0} ) Δα - {C}_{L} cos {α}_{0} - {C}_{D} sin {α}_{0} + ( {C}_{L} sin {α}_{0} - {C}_{D} cos {α}_{0} ) Δα$$

$${C}_{L} sin ( {α}_{0} + Δα ) - {C}_{D} cos ( {α}_{0} + Δα ) + {C}_{L} cos ( {α}_{0} + Δα ) + {C}_{D} sin ( {α}_{0} + Δα ) == sin {α}_{0} {C}_{L} ( 1 - Δα ) - cos {α}_{0} {C}_{D} ( 1 - Δα ) + cos {α}_{0} {C}_{L} ( 1 + Δα ) + sin {α}_{0} {C}_{D} ( 1 + Δα )$$

$${C}_{L} sin ( {α}_{0} + Δα ) - {C}_{D} cos ( {α}_{0} + Δα ) - {C}_{L} cos ( {α}_{0} + Δα ) - {C}_{D} sin ( {α}_{0} + Δα ) == sin {α}_{0} {C}_{L} ( 1 + Δα ) - cos {α}_{0} {C}_{D} ( 1 + Δα ) - cos {α}_{0} {C}_{L} ( 1 - Δα ) - sin {α}_{0} {C}_{D} ( 1 - Δα )$$

$$Δα ≪ 1$$

$${C}_{L} sin ( {α}_{0} + Δα ) - {C}_{D} cos ( {α}_{0} + Δα ) + {C}_{L} cos ( {α}_{0} + Δα ) + {C}_{D} sin ( {α}_{0} + Δα ) \approx \approx sin {α}_{0} {C}_{L} - cos {α}_{0} {C}_{D} + cos {α}_{0} {C}_{L} + sin {α}_{0} {C}_{D}$$

$${C}_{L} sin ( {α}_{0} + Δα ) - {C}_{D} cos ( {α}_{0} + Δα ) - {C}_{L} cos ( {α}_{0} + Δα ) - {C}_{D} sin ( {α}_{0} + Δα ) \approx \approx sin {α}_{0} {C}_{l} - cos {α}_{0} {C}_{D} - cos {α}_{0} {C}_{L} - sin {α}_{0} {C}_{D}$$

$$\frac{1}{2} κ {p}_{0} δ {M}^{2} S ( sin {α}_{0} {C}_{L} - cos {α}_{0} {C}_{D} + cos {α}_{0} {C}_{L} + sin {α}_{0} {C}_{D} ) + {W}_{MTOW} δ {C}_{T} ( 1 + ɛ ) = {m}_{0} ( {a}_{1 , 0}^{BFS} - {a}_{3 , 0}^{BFS} + Δ {a}_{1}^{BFS} - Δ {a}_{3}^{BFS} )$$

$$\frac{1}{2} κ {p}_{0} δ {M}^{2} S ( sin {α}_{0} {C}_{L} - cos {α}_{0} {C}_{D} - cos {α}_{0} {C}_{L} - sin {α}_{0} {C}_{D} ) + {W}_{MTOW} δ {C}_{T} ( 1 - ɛ ) = {m}_{0} ( {a}_{1 , 0}^{BFS} + {a}_{3 , 0}^{BFS} + Δ {a}_{1}^{BFS} + Δ {a}_{3}^{BFS} )$$

$$\frac{1}{2} κ {p}_{0} δ {M}^{2} S ( sin {α}_{0} {C}_{L} - cos {α}_{0} {C}_{D} ) + {W}_{MTOW} δ {C}_{T} = {m}_{0} ( {a}_{1 , 0}^{BFS} + Δ {a}_{1}^{BFS} ) - \frac{1}{2} κ {p}_{0} δ {M}^{2} S ( cos {α}_{0} {C}_{L} + sin {α}_{0} {C}_{D} ) - {W}_{MTOW} δ {C}_{T} ɛ = {m}_{0} ( {a}_{3 , 0}^{BFS} + Δ {a}_{3}^{BFS} )$$

$$\frac{1}{2} κ {p}_{0} δ {M}^{2} S [ sin {α}_{0} ( {C}_{L , 0} + Δ {C}_{L} ) - cos {α}_{0} ( {C}_{D , 0} + Δ {C}_{D} ) ] + {W}_{MTOW} δ ( {C}_{T , 0} + {C}_{T , M} Δ M ) = {m}_{0} ( {a}_{1 , 0}^{BFS} + Δ {a}_{1}^{BFS} ) - \frac{1}{2} κ {p}_{0} δ {M}^{2} S [ cos {α}_{0} ( {C}_{L , 0} + Δ {C}_{L} ) + sin {α}_{0} ( {C}_{D , 0} + Δ {C}_{D} ) ] - {W}_{MTOW} δ ( {C}_{T , 0} + {C}_{T , M} Δ M ) ɛ = {m}_{0} ( {a}_{3 , 0}^{BFS} + Δ {a}_{3}^{BFS} )$$

$$\frac{1}{2} κ {p}_{0} δ {M}^{2} S ( sin {α}_{0} {C}_{L , 0} - cos {α}_{0} {C}_{D , 0} ) + \frac{1}{2} κ {p}_{0} δ {M}^{2} S ( sin {α}_{0} Δ {C}_{L} - cos {α}_{0} Δ {C}_{D} ) + {W}_{MTOW} δ ( {C}_{T , 0} + {C}_{T , M} Δ M ) = {m}_{0} ( {a}_{1 , 0}^{BFS} + Δ {a}_{1}^{BFS} ) - \frac{1}{2} κ {p}_{0} δ {M}^{2} S ( cos {α}_{0} {C}_{L , 0} + sin {α}_{0} {C}_{D , 0} ) - \frac{1}{2} κ {p}_{0} δ {M}^{2} S ( cos {α}_{0} Δ {C}_{L} + sin {α}_{0} Δ {C}_{D} ) - {W}_{MTOW} δ ( {C}_{T , 0} + {C}_{T , M} Δ M ) ɛ = {m}_{0} ( {a}_{3 , 0}^{BFS} + Δ {a}_{3}^{BFS} )$$

$${M}^{2} = {( {M}_{0} + Δ M )}^{2} = {M}_{0}^{2} + 2 {M}_{0} Δ M + Δ {M}^{2} = {M}_{0}^{2} [ 1 + 2 \frac{Δ M}{{M}_{0}} + {( \frac{Δ M}{{M}_{0}} )}^{2} ]$$

$$\frac{Δ M}{{M}_{0}} ≪ 1$$

$${M}^{2} \approx {M}_{0}^{2} ( 1 + 2 \frac{Δ M}{{M}_{0}} )$$

$$\frac{1}{2} κ {p}_{0} δ S ( {M}_{0}^{2} + 2 {M}_{0} Δ M ) ( sin {α}_{0} {C}_{L , 0} - cos {α}_{0} {C}_{D , 0} ) + \frac{1}{2} κ {p}_{0} δ {SM}^{2} ( sin {α}_{0} Δ {C}_{L} - cos {α}_{0} Δ {C}_{D} ) + {W}_{MTOW} δ ( {C}_{T , 0} + {C}_{T , M} Δ M ) == {m}_{0} ( {a}_{1 , 0}^{BFS} + Δ {a}_{1}^{BFS} ) - \frac{1}{2} κ {p}_{0} δ S ( {M}_{0}^{2} + 2 {M}_{0} Δ M ) ( cos {α}_{0} {C}_{L , 0} + sin {α}_{0} {C}_{D , 0} ) - \frac{1}{2} κ {p}_{0} δ {SM}^{2} ( cos {α}_{0} Δ {C}_{L} + sin {α}_{0} Δ {C}_{D} ) - {W}_{MTOW} δ ( {C}_{T , 0} + {C}_{T , M} Δ M ) ɛ == {m}_{0} ( {a}_{3 , 0}^{BFS} + Δ {a}_{3}^{BFS} )$$

Bearing in mind [247]:

$$κ {p}_{0} δ {SM}_{0} Δ M ( sin {α}_{0} {C}_{L , 0} - cos {α}_{0} {C}_{D , 0} ) + \frac{1}{2} κ {p}_{0} δ {SM}^{2} ( sin {α}_{0} Δ {C}_{L} - cos {α}_{0} Δ {C}_{D} ) + {W}_{MTOW} δ {C}_{T , m} Δ M = {m}_{0} Δ {a}_{1}^{BFS} - κ {p}_{0} δ {SM}_{0} Δ M ( cos {α}_{0} {C}_{L , 0} + sin {α}_{0} {C}_{D , 0} ) - \frac{1}{2} κ {p}_{0} δ {SM}^{2} ( cos {α}_{0} Δ {C}_{L} + sin {α}_{0} Δ {C}_{D} ) - {W}_{MTOW} δ {C}_{T , m} Δ M ɛ = {m}_{0} Δ {a}_{3}^{BFS}$$

$$κ {p}_{0} δ {SM}_{0} ( sin {α}_{0} {C}_{L , 0} - cos {α}_{0} {C}_{D , 0} ) Δ M ++ \frac{1}{2} κ {p}_{0} δ {M}^{2} S [ sin {α}_{0} ( {C}_{L , α} Δα + {C}_{L , M} Δ M + {C}_{L , \dot{α}} \frac{\dot{α}}{M} + {C}_{L , q} \frac{q}{M} ) - cos {α}_{0} ( {C}_{D , α} Δα + {C}_{D , M} Δ M + {C}_{D , \dot{α}} \frac{\dot{α}}{M} + {C}_{D , q} \frac{q}{M} ) ] ++ {W}_{MTOW} δ {C}_{T , M} Δ M = {m}_{0} Δ {a}_{1}^{BFS} - κ {p}_{0} δ {SM}_{0} ( cos {α}_{0} {C}_{L , 0} + sin {α}_{0} {C}_{D , 0} ) Δ M -- \frac{1}{2} κ {p}_{0} δ {M}^{2} S [ cos {α}_{0} ( {C}_{L , α} Δα + {C}_{L , M} Δ M + {C}_{L , \dot{α}} \frac{\dot{α}}{M} + {C}_{L , q} \frac{q}{M} ) + sin {α}_{0} ( {C}_{D , α} Δα + {C}_{D , M} Δ M + {C}_{D , \dot{α}} \frac{\dot{α}}{M} + {C}_{D , q} \frac{q}{M} ) ] - {W}_{MTOW} δ {C}_{T , M} Δ M ɛ = {m}_{0} Δ {a}_{3}^{BFS}$$

$${M}^{2} Δ M = {( {M}_{0} + Δ M )}^{2} Δ M = ( {M}_{0}^{2} + 2 {M}_{0} Δ M + Δ {M}^{2} ) Δ M = {M}_{0}^{2} [ 1 + 2 \frac{Δ M}{{M}_{0}} + {( \frac{Δ M}{{M}_{0}} )}^{2} ] Δ M \approx {M}_{0}^{2} ( 1 + 2 \frac{Δ M}{{M}_{0}} ) Δ M$$

$${C}_{X , M} = \frac{2}{{M}_{0}} ( sin {α}_{0} {C}_{L , 0} - cos {α}_{0} {C}_{D , 0} ) + ( sin {α}_{0} {C}_{L , M} - cos {α}_{0} {C}_{D , M} ) + \frac{{W}_{MTOW} {C}_{T , M}}{\frac{1}{2} κ {p}_{0} {SM}_{0}^{2}}$$

$${C}_{Z , M} = \frac{2}{{M}_{0}} ( cos {α}_{0} {C}_{L , 0} + sin {α}_{0} {C}_{D , 0} ) + ( cos {α}_{0} {C}_{L , M} + sin {α}_{0} {C}_{D , M} ) + \frac{{W}_{MTOW} {C}_{T , M}}{\frac{1}{2} κ {p}_{0} {SM}_{0}^{2}} ɛ$$

$$\frac{1}{2} κ {p}_{0} δ {SM}_{0}^{2} {C}_{X , M} Δ M ++ \frac{1}{2} κ {p}_{0} δ S [ {M}^{2} ( sin {α}_{0} {C}_{L , α} - cos {α}_{0} {C}_{D , α} ) Δα + 2 {M}_{0} ( sin {α}_{0} {C}_{L , M} - cos {α}_{0} {C}_{D , M} ) Δ {M}^{2} + M ( sin {α}_{0} {C}_{L , \dot{α}} - cos {α}_{0} {C}_{D , \dot{α}} ) \dot{α} + M ( sin {α}_{0} {C}_{L , q} - cos {α}_{0} {C}_{D , q} ) q ] == {m}_{0} Δ {a}_{1}^{BFS} - \frac{1}{2} κ {p}_{0} δ {SM}_{0}^{2} {C}_{Z , M} Δ M -- \frac{1}{2} κ {p}_{0} δ S [ {M}^{2} ( cos {α}_{0} {C}_{L , α} + sin {α}_{0} {C}_{D , α} ) Δα + 2 {M}_{0} ( cos {α}_{0} {C}_{L , M} + sin {α}_{0} {C}_{D , M} ) Δ {M}^{2} + M ( cos {α}_{0} {C}_{L , \dot{α}} + sin {α}_{0} {C}_{D , \dot{α}} ) \dot{α} + M ( cos {α}_{0} {C}_{L , q} + sin {α}_{0} {C}_{D , q} ) q ] == {m}_{0} Δ {a}_{3}^{BFS}$$

$${C}_{X , α} = sin {α}_{0} {C}_{L , α} - cos {α}_{0} {C}_{D , α}$$

$${C}_{Z , α} = cos {α}_{0} {C}_{L , α} + sin {α}_{0} {C}_{D , α}$$

$${C}_{X , Δ M} = sin {α}_{0} {C}_{L , M} - cos {α}_{0} {C}_{D , M}$$

$${C}_{Z , Δ M} = cos {α}_{0} {C}_{L , M} + sin {α}_{0} {C}_{D , M}$$

$${C}_{X , \dot{α}} = sin {α}_{0} {C}_{L , \dot{α}} - cos {α}_{0} {C}_{D , \dot{α}}$$

$${C}_{Z , \dot{α}} = cos {α}_{0} {C}_{L , α} + sin {α}_{0} {C}_{D , \dot{α}}$$

$${C}_{X , q} = sin {α}_{0} {C}_{L , q} - cos {α}_{0} {C}_{D , q}$$

$${C}_{Z , q} = cos {α}_{0} {C}_{L , q} + sin {α}_{0} {C}_{D , q}$$

$$\frac{1}{2} κ {p}_{0} δ S ( {M}_{0}^{2} {C}_{X , M} Δ M + {M}^{2} {C}_{X , α} Δα + 2 {M}_{0} {C}_{X , Δ M} Δ {M}^{2} + {MC}_{X , \dot{α}} \dot{α} + {MC}_{X , q} q ) = {m}_{0} Δ {a}_{1}^{BFS} - \frac{1}{2} κ {p}_{0} δ S ( {M}_{0}^{2} {C}_{Z , M} Δ M + {M}^{2} {C}_{Z , α} Δα + 2 {M}_{0} {C}_{Z , Δ M} Δ {M}^{2} + {MC}_{Z , \dot{α}} \dot{α} + {MC}_{Z , q} q ) = {m}_{0} Δ {a}_{3}^{BFS}$$

$$\frac{1}{2} κ {p}_{0} δ S [ {M}_{0}^{2} {C}_{X , M} Δ M + {M}_{0}^{2} ( 1 + 2 \frac{Δ M}{{M}_{0}} ) {C}_{X , α} Δα + 2 {M}_{0} {C}_{X , Δ M} Δ {M}^{2} + ( {M}_{0} + Δ M ) {C}_{X , \dot{α}} \dot{α} + ( {M}_{0} + Δ M ) {C}_{X , q} q ] = {m}_{0} Δ {a}_{1}^{BFS} - \frac{1}{2} κ {p}_{0} δ S [ {M}_{0}^{2} {C}_{Z , M} Δ M + {M}_{0}^{2} ( 1 + 2 \frac{Δ M}{{M}_{0}} ) {C}_{Z , α} Δα + 2 {M}_{0} {C}_{Z , Δ M} Δ {M}^{2} + ( {M}_{0} + Δ M ) {C}_{Z , \dot{α}} \dot{α} + ( {M}_{0} + Δ M ) {C}_{Z , q} q ] = {m}_{0} Δ {a}_{3}^{BFS}$$

$$\frac{1}{2} κ {p}_{0} δ {SM}_{0}^{2} [ {C}_{X , α} Δα + {C}_{X , M} Δ M + \frac{{C}_{X , \dot{α}}}{{M}_{0}} \dot{α} + \frac{{C}_{X , q}}{{M}_{0}} q + ( 2 \frac{{C}_{X , α}}{{M}_{0}} Δα + 2 \frac{{C}_{X , Δ M}}{{M}_{0}} Δ M + \frac{{C}_{X , \dot{α}}}{{M}_{0}^{2}} \dot{α} + \frac{{C}_{X , q}}{{M}_{0}^{2}} q ) Δ M ] = {m}_{0} Δ {a}_{1}^{BFS} - \frac{1}{2} κ {p}_{0} δ {SM}_{0}^{2} [ {C}_{Z , α} Δα + {C}_{Z , M} Δ M + \frac{{C}_{Z , \dot{α}}}{{M}_{0}} \dot{α} + \frac{{C}_{Z , q}}{{M}_{0}} q + ( 2 \frac{{C}_{Z , α}}{{M}_{0}} Δα + 2 \frac{{C}_{Z , Δ M}}{{M}_{0}} Δ M + \frac{{C}_{Z , \dot{α}}}{{M}_{0}^{2}} \dot{α} + \frac{{C}_{Z , q}}{{M}_{0}^{2}} q ) Δ M ] = {m}_{0} Δ {a}_{3}^{BFS}$$

$$\frac{1}{2} κ {p}_{0} δ {Sc}_{Z , \dot{α}} ( {M}_{0}^{2} {C}_{X , M} Δ M + {M}^{2} {C}_{X , α} Δα + 2 {M}_{0} {C}_{X , Δ M} Δ {M}^{2} + {MC}_{X , \dot{α}} \dot{α} + {MC}_{X , q} q ) = {m}_{0} {C}_{Z , \dot{α}} Δ {a}_{1}^{BFS} - \frac{1}{2} κ {p}_{0} δ {SC}_{X , \dot{α}} ( {M}_{0}^{2} {C}_{Z , M} Δ M + {M}^{2} {C}_{Z , α} Δα + 2 {M}_{0} {C}_{Z , Δ M} Δ {M}^{2} + {MC}_{Z , \dot{α}} \dot{α} + {MC}_{Z , q} q ) = {m}_{0} {C}_{X , \dot{α}} Δ {a}_{3}^{BFS}$$

$$\frac{1}{2} κ {p}_{0} δ S [ {M}_{0}^{2} ( {C}_{Z , \dot{α}} {C}_{X , M} - {C}_{X , \dot{α}} {C}_{Z , M} ) Δ M + {M}^{2} ( {C}_{Z , \dot{α}} {C}_{X , α} - {C}_{X , \dot{α}} {C}_{Z , α} ) Δα + 2 {M}_{0} ( {C}_{Z , \dot{α}} {C}_{X , Δ M} - {C}_{X , \dot{α}} {C}_{Z , Δ M} ) Δ {M}^{2} + M ( {C}_{Z , \dot{α}} {C}_{X , q} - {C}_{X , \dot{α}} {C}_{Z , q} ) q ] == {m}_{0} ( {C}_{Z , \dot{α}} Δ {a}_{1}^{BFS} + {C}_{X , \dot{α}} Δ {a}_{3}^{BFS} )$$

$$\frac{1}{2} κ {p}_{0} δ S [ {M}_{0}^{2} ( {C}_{Z , \dot{α}} {C}_{X , M} + {C}_{X , \dot{α}} {C}_{Z , M} ) Δ M + {M}^{2} ( {C}_{Z , \dot{α}} {C}_{X , α} + {C}_{X , \dot{α}} {C}_{Z , α} ) Δα + 2 {M}_{0} ( {C}_{Z , \dot{α}} {C}_{X , Δ M} + {C}_{X , \dot{α}} {C}_{Z , Δ M} ) Δ {M}^{2} + 2 {MC}_{X , \dot{α}} {C}_{Z , \dot{α}} \dot{α} + M ( {C}_{Z , \dot{α}} {C}_{X , q} + {C}_{X , \dot{α}} {C}_{Z , q} ) q ] == {m}_{0} ( {C}_{Z , \dot{α}} Δ {a}_{1}^{BFS} - {C}_{X , \dot{α}} Δ {a}_{3}^{BFS} )$$

$${C}_{1} = {C}_{Z , \dot{α}} {C}_{X , M} - {C}_{X , \dot{α}} {C}_{Z , M}$$

$${C}_{2} = {C}_{Z , \dot{α}} {C}_{X , α} - {C}_{X , \dot{α}} {C}_{Z , α}$$

$${C}_{3} = {C}_{Z , \dot{α}} {C}_{X , Δ M} - {C}_{X , \dot{α}} {C}_{Z , Δ M}$$

$${C}_{4} = {C}_{Z , \dot{α}} {C}_{X , q} - {C}_{X , \dot{α}} {C}_{Z , q}$$

$${D}_{1} = {C}_{Z , \dot{α}} {C}_{X , M} + {C}_{X , \dot{α}} {C}_{Z , M}$$

$${D}_{2} = {C}_{Z , \dot{α}} {C}_{X , α} + {C}_{X , \dot{α}} {C}_{Z , α}$$

$${D}_{3} = {C}_{Z , \dot{α}} {C}_{X , Δ M} + {C}_{X , \dot{α}} {C}_{Z , Δ M}$$

$${D}_{4} = {C}_{Z , \dot{α}} {C}_{X , q} + {C}_{X , \dot{α}} {C}_{Z , q}$$

$${D}_{5} = 2 {C}_{X , \dot{α}} {C}_{Z , \dot{α}}$$

$$\frac{1}{2} κ {p}_{0} δ S ( {M}_{0}^{2} {C}_{1} Δ M + {M}^{2} {C}_{2} Δα + 2 {M}_{0} {C}_{3} Δ {M}^{2} + {MC}_{4} q ) = {m}_{0} ( {C}_{Z , \dot{α}} Δ {a}_{1}^{BFS} + {C}_{X , \dot{α}} Δ {a}_{3}^{BFS} )$$

$$\frac{1}{2} κ {p}_{0} δ S ( {M}_{0}^{2} {D}_{1} Δ M + {M}^{2} {D}_{2} Δα + 2 {M}_{0} {D}_{3} Δ {M}^{2} + {MD}_{4} \dot{α} + {MD}_{5} q ) = {m}_{0} ( {C}_{Z , \dot{α}} Δ {a}_{1}^{BFS} - {C}_{X , \dot{α}} Δ {a}_{3}^{BFS} )$$

$$\frac{1}{2} κ {p}_{0} δ {SD}_{3} ( {M}_{0}^{2} {C}_{1} Δ M + {M}^{2} {C}_{2} Δα + 2 {M}_{0} {C}_{3} Δ {M}^{2} + {MC}_{4} q ) = {m}_{0} {D}_{3} ( {C}_{Z , \dot{α}} Δ {a}_{1}^{BFS} + {C}_{X , \dot{α}} Δ {a}_{3}^{BFS} )$$

$$\frac{1}{2} κ {p}_{0} δ {SC}_{3} ( {M}_{0}^{2} {D}_{1} Δ M + {M}^{2} {D}_{2} Δα + 2 {M}_{0} {D}_{3} Δ {M}^{2} + {MD}_{4} q + {MD}_{5} \dot{α} ) = {m}_{0} {C}_{3} ( {C}_{Z , \dot{α}} Δ {a}_{1}^{BFS} - {C}_{X , \dot{α}} Δ {a}_{3}^{BFS} )$$

$$\frac{1}{2} κ {p}_{0} δ S [ {M}_{0}^{2} ( {C}_{1} {D}_{3} - {C}_{3} {D}_{1} ) Δ M + {M}^{2} ( {C}_{2} {D}_{3} - {C}_{3} {D}_{2} ) Δα + M ( {C}_{4} {D}_{3} - {C}_{3} {D}_{4} ) q - {MC}_{3} {D}_{5} \dot{α} ] = {m}_{0} [ Δ {a}_{1}^{BFS} {C}_{Z , \dot{α}} ( {D}_{3} - {C}_{3} ) + Δ {a}_{3}^{BFS} {C}_{X , \dot{α}} ( {D}_{3} + {C}_{3} ) ]$$

$${F}_{1} = {C}_{1} {D}_{3} - {C}_{3} {D}_{1}$$

$${F}_{2} = {C}_{2} {D}_{3} - {C}_{3} {D}_{2}$$

$${F}_{3} = {C}_{4} {D}_{3} - {C}_{3} {D}_{4}$$

$${F}_{4} = {C}_{3} {D}_{5}$$

$${F}_{5} = {C}_{Z , \dot{α}} ( {D}_{3} - {C}_{3} ) = 2 {C}_{Z , \dot{α}} {C}_{X , \dot{α}} {C}_{Z , Δ M}$$

$${F}_{6} = {C}_{X , \dot{α}} ( {D}_{3} + {C}_{3} ) = 2 {C}_{X , \dot{α}} {C}_{Z , \dot{α}} {C}_{X , Δ M}$$

$$\frac{1}{2} κ {p}_{0} δ S ( {M}_{0}^{2} {F}_{1} Δ M + {M}^{2} {F}_{2} Δα + {MF}_{3} q - {MF}_{4} \dot{α} ) = {m}_{0} ( {F}_{5} Δ {a}_{1}^{BFS} + {F}_{6} Δ {a}_{3}^{BFS} )$$

$$\frac{1}{2} κ {p}_{0} δ {SMF}_{4} \dot{α} \frac{{C}_{P , \dot{α}}}{{C}_{P , \dot{α}}} = \frac{1}{2} κ {p}_{0} δ S ( {M}_{0}^{2} {F}_{1} Δ M + {M}^{2} {F}_{2} Δα + {MF}_{3} q ) = {m}_{0} ( {F}_{5} Δ {a}_{1}^{BFS} + {F}_{6} Δ {a}_{3}^{BFS} ) = \frac{1}{2} κ {p}_{0} δ S [ {M}_{0}^{2} {F}_{1} Δ M + {M}^{2} {F}_{2} Δα + {MF}_{3} q - \frac{{m}_{0}}{\frac{1}{2} κ {p}_{0} δ S} ( {F}_{5} Δ {a}_{1}^{BFS} + {F}_{6} Δ {a}_{3}^{BFS} ) ]$$

$$M \dot{α} = \frac{1}{{F}_{4}} [ {M}_{0}^{2} {F}_{1} Δ M + {M}^{2} {F}_{2} Δα + {MF}_{3} q - \frac{{m}_{0}}{\frac{1}{2} κ {p}_{0} δ S} ( {F}_{5} Δ {a}_{1}^{BFS} + {F}_{6} Δ {a}_{3}^{BFS} ) ]$$

Lateral-directional motion with pitch rate-on-elevator to ensure q≡\dot{α}≡0:

−D sin β−Q cos β−Tυ=ma₂^{BFS} [287]

Close enough to the balanced flight condition and, as E, is held close to null, εₐ and εᵣ are held null and ε_{h,0} is held constant, the aerodynamic drag and side-force coefficients can be approximated by the respective Taylor expansions in the form:

$$\begin{matrix}{C}_{D} ( α , β , M , 0 , \hat{\dot{β}} , \hat{p} , 0 , \hat{r} , {ɛ}_{h , 0} , 0 , 0 , 0 ) = {C}_{D} ( α , β , M , \hat{\dot{β}} , \hat{p} , \hat{r} ) = {C}_{D , 0} + {C}_{D , α} Δ α + {C}_{D , β} β + {C}_{D , M} Δ M + {C}_{D , \hat{\dot{β}}} \hat{\dot{β}} + {C}_{D , \hat{p}} \hat{p} + {C}_{D , \hat{r}} \hat{r} = {C}_{D , 0} + Δ {C}_{D} & [ 288 ] \\ {C}_{D} ( α , β , M , 0 , \hat{\dot{β}} , \hat{p} , 0 , \hat{r} , {ɛ}_{h , 0} , 0 , 0 , 0 ) = {C}_{Q} ( α , β , M , \hat{\dot{β}} , \hat{p} , \hat{r} ) = {C}_{Q , 0} + {C}_{Q , α} Δ α + {C}_{Q , β} Δ β + {C}_{Q , M} Δ M + {C}_{Q , \hat{\dot{β}}} \hat{\dot{β}} + {C}_{Q , \hat{p}} \hat{p} + {C}_{Q , \hat{r}} \hat{r} = {C}_{Q , 0} + Δ {C}_{Q} & [ 289 ] \\ {C}_{D , \hat{\dot{β}}} \hat{\dot{β}} = {C}_{D , \hat{\dot{β}}} \frac{\dot{β} {b}_{w}}{2 {v}_{TAS}} = {C}_{D , \hat{\dot{β}}} \frac{{b}_{w}}{2 {a}_{0}} \frac{\dot{β}}{M} = {C}_{D , \dot{β}} \frac{\dot{β}}{M} \\ {C}_{D , \dot{β}} = {C}_{D , \hat{\dot{β}}} \frac{{b}_{w}}{2 {a}_{0}} & [ 290 ] \\ {C}_{Q , \hat{\dot{β}}} \hat{\dot{β}} = {C}_{Q , \hat{\dot{β}}} \frac{\dot{β} {b}_{w}}{2 {v}_{TAS}} = {C}_{Q , \hat{\dot{β}}} \frac{{b}_{w}}{2 {a}_{0}} \frac{\dot{β}}{M} = {C}_{Q , \dot{β}} \frac{\dot{β}}{M} \\ {C}_{Q , \dot{β}} = {C}_{Q , \hat{\dot{β}}} \frac{{b}_{w}}{2 {a}_{0}} & [ 291 ] \\ {C}_{D , \hat{p}} \hat{p} = {C}_{D , \hat{p}} \frac{q {b}_{w}}{2 {v}_{TAS}} = {C}_{D , \hat{p}} \frac{{b}_{w}}{2 {a}_{0}} \frac{p}{M} = {C}_{D , p} \frac{p}{M} \\ {C}_{D , p} = {C}_{D , \hat{p}} \frac{{b}_{w}}{2 {a}_{0}} & [ 292 ] \\ {C}_{D , \hat{r}} \hat{r} = {C}_{D , \hat{r}} \frac{{qb}_{w}}{2 {v}_{TAS}} = {C}_{D , \hat{r}} \frac{{b}_{w}}{2 {a}_{0}} \frac{r}{M} = {C}_{D , r} \frac{r}{M} \\ {C}_{D , r} = {C}_{D , \hat{r}} \frac{{b}_{w}}{2 {a}_{0}} & [ 293 ] \\ {C}_{Q , \hat{p}} \hat{p} = {C}_{Q , \hat{p}} \frac{q {b}_{w}}{2 {v}_{TAS}} = {C}_{Q , \hat{p}} \frac{{b}_{w}}{2 {a}_{0}} \frac{p}{M} = {C}_{Q , p} \frac{p}{M} \\ {C}_{Q , p} = {C}_{Q , \hat{p}} \frac{{b}_{w}}{2 {a}_{0}} & [ 294 ] \\ {C}_{Q , \hat{r}} \hat{r} = {C}_{Q , \hat{r}} \frac{q {b}_{w}}{2 {v}_{TAS}} = {C}_{Q , \hat{r}} \frac{{b}_{w}}{2 {a}_{0}} \frac{r}{M} = {C}_{Q , r} \frac{r}{M} \\ {C}_{Q , r} = {C}_{Q , \hat{r}} \frac{{b}_{w}}{2 {a}_{0}} & [ 295 ] \\ {C}_{D} ( α , β , M , \hat{\dot{β}} , \hat{p} , \hat{r} ) = {C}_{D , 0} + {C}_{D , α} Δ α + {C}_{D , β} β + {C}_{D , M} Δ M + {C}_{D , \dot{β}} \frac{\dot{β}}{M} + {C}_{D , p} \frac{p}{M} + {C}_{D , r} \frac{r}{m} & [ 296 ] \\ {C}_{Q} ( α , β , M , \hat{\dot{β}} , \hat{p} , \hat{r} ) = {C}_{Q , 0} + {C}_{Q , α} Δ α + {C}_{Q , β} β + {C}_{Q , M} Δ M + {C}_{Q , \dot{β}} \frac{\dot{β}}{M} + {C}_{Q , p} \frac{p}{M} + {C}_{Q , r} \frac{r}{m} & [ 297 ]\end{matrix}$$

As for the thrust coefficient, expression [246] still applies.

At the balanced flight condition:

½κp₀δM₀²SC_{Q,0}−W_{MTOW}δC_{T,0}υ=m₀a_{2,0}^{BFS} [298]

And close enough to the balanced flight condition:

$$\frac{1}{2} κ {p}_{0} δ {M}^{2} S ( - {C}_{D} sin β - {C}_{Q} cos β ) - {W}_{MTOW} δ {C}_{T} υ = {m}_{0} ( {a}_{2 , 0}^{BFS} + Δ {a}_{2}^{BFS} )$$

$$Δ {a}_{2}^{BFS} = {a}_{2}^{BFS} - {a}_{2 , 0}^{BFS}$$

$$\frac{1}{2} κ {p}_{0} δ {M}^{2} S [ - ( {C}_{D , 0} + Δ {C}_{D} ) sin β - ( {C}_{Q , 0} + Δ {C}_{Q} ) cos β ] - {W}_{MTOW} δ ( {C}_{T , 0} + {C}_{T , M} Δ M ) υ = {m}_{0} ( {a}_{2 , 0}^{BFS} + Δ {a}_{2}^{BFS} )$$

Bearing in mind [298]:

$$\frac{1}{2} κ {p}_{0} δ {M}^{2} S ( - Δ {C}_{D} sin β - Δ {C}_{Q} cos β ) - {W}_{MTOW} δ {C}_{T , M} υΔ M = {m}_{0} Δ {a}_{2}^{BFS}$$

$$β ≪ 1$$

$$\frac{1}{2} κ {p}_{0} δ {M}^{2} S ( - Δ {C}_{D} β - Δ {C}_{Q} ) - {W}_{MTOW} δ {C}_{T , M} υΔ M = {m}_{0} Δ {a}_{2}^{BFS}$$

$$\frac{1}{2} κ {p}_{0} δ {M}^{2} S [ - ( {C}_{D , α} Δα + {C}_{D , β} β + {C}_{D , M} Δ M + {C}_{D , \dot{β}} \frac{\dot{β}}{M} + {C}_{D , p} \frac{p}{M} + {C}_{D , r} \frac{r}{M} ) β - ( {C}_{Q , α} Δα + {C}_{Q , β} β + {C}_{Q , M} Δ M + {C}_{Q , \dot{β}} \frac{\dot{β}}{M} + {C}_{Q , p} \frac{p}{M} + {C}_{Q , r} \frac{r}{M} ) ] - {W}_{MTOW} δ {C}_{T , M} Δ M υ = {m}_{0} Δ {a}_{2}^{BFS}$$

$$\frac{1}{2} κ {p}_{0} δ {M}^{2} S [ - \frac{\dot{β}}{M} ( {C}_{D , \dot{β}} β + {C}_{Q , \dot{β}} ) - ( {C}_{D , α} Δα + {C}_{D , β} β + {C}_{D , M} Δ M + {C}_{D , p} \frac{p}{M} + {C}_{D , r} \frac{r}{M} ) β - ( {C}_{Q , α} Δα + {C}_{Q , β} β + {C}_{Q , M} Δ M + {C}_{Q , p} \frac{p}{M} + {C}_{Q , r} \frac{r}{M} ) ] - {W}_{MTOW} δ {C}_{T , M} Δ M υ = {m}_{0} Δ {a}_{2}^{BFS}$$

$$M \dot{β} = - \frac{1}{{C}_{D , \dot{β}} β + {C}_{Q , \dot{β}}} [ {M}^{2} [ ( {C}_{D , α} Δα + {C}_{D , β} β + {C}_{D , M} Δ M + {C}_{D , p} \frac{p}{M} + {C}_{D , r} \frac{r}{M} ) β + ( {C}_{Q , α} Δα + {C}_{Q , β} β + {C}_{Q , M} Δ M + {C}_{Q , p} \frac{p}{M} + {C}_{Q , r} \frac{r}{M} ) ] + \frac{{W}_{MTOW} {C}_{T , M}}{\frac{1}{2} κ {p}_{o} S} υΔ M + \frac{{m}_{0}}{\frac{1}{2} κ {p}_{o} δ} Δ {a}_{2}^{BFS} ] \\ \frac{1}{{C}_{D , \dot{β}} β + {C}_{Q , \dot{β}}} = \frac{1}{{C}_{Q , \dot{β}} ( 1 + \frac{{C}_{D , \dot{β}}}{{C}_{Q , \dot{β}}} β )} \\ \vert k \vert = \vert \frac{{C}_{D , \dot{β}}}{{C}_{Q , \dot{β}}} \vert < 1 \begin{matrix}Side force changes faster with a \\ variation of AOS than drag does\end{matrix} \\ \frac{1}{{C}_{D , \dot{β}} β + {C}_{Q , \dot{β}}} = \frac{1}{{C}_{Q , \dot{β}} ( 1 + k β )} \approx \frac{1}{{C}_{Q , \dot{β}}} ( 1 - k β ) \approx \frac{1}{{C}_{Q , \dot{β}}} Taylor expansion \\ M \dot{β} = - \frac{1}{{C}_{Q , \dot{β}}} [ {M}^{2} [ ( {C}_{D , α} Δα + {C}_{D , β} β + {C}_{D , M} Δ M + {C}_{D , p} \frac{p}{M} + {C}_{D , r} \frac{r}{M} ) β + ( {C}_{Q , α} Δα + {C}_{Q , β} β + {C}_{Q , M} Δ M + {C}_{Q , p} \frac{p}{M} + {C}_{Q , r} \frac{r}{M} ) ] + \frac{{W}_{MTOW} {C}_{T , M}}{\frac{1}{2} κ {p}_{0} S} υΔ M + \frac{{m}_{0}}{\frac{1}{2} κ {p}_{0} δ} Δ {a}_{2}^{BFS} ] \\ M \dot{β} = - \frac{1}{{C}_{Q , \dot{β}}} [ ( {M}^{2} {C}_{D , α} Δα + {M}^{2} {C}_{D , β} β + {M}^{2} {C}_{D , M} Δ M + {MC}_{D , p} p + {MC}_{D , r} r ) β + ( {M}^{2} {C}_{Q , α} Δα + {M}^{2} {C}_{Q , β} β + {M}^{2} {C}_{Q , M} Δ M + {MC}_{Q , p} p + {MC}_{Q , r} r ) + \frac{{W}_{MTOW} {C}_{T , M}}{\frac{1}{2} κ {p}_{0} S} υΔ M + \frac{{m}_{0}}{\frac{1}{2} κ {p}_{0} δ} Δ {a}_{2}^{BFS} ]$$

Taking into account [263]:

$$M \dot{β} = - \frac{1}{{C}_{Q , \dot{β}}} [ {M}^{2} {C}_{D , α} Δαβ + {M}^{2} {C}_{D , β} {β}^{2} + {M}^{2} {C}_{D , M} Δ M β + {MC}_{D , p} p β + {MC}_{D , r} r β + {M}^{2} {C}_{Q , α} Δα + {M}^{2} {C}_{Q , β} β + {M}_{0}^{2} ( 1 + 2 \frac{Δ M}{{M}_{0}} ) {C}_{Q , M} Δ M + {MC}_{Q , p} p + {MC}_{Q , r} r + \frac{{W}_{MTOW} {C}_{T , M}}{\frac{1}{2} κ {p}_{0} δ} Δ {a}_{2}^{BFS} ]$$

$${C}_{y , M} = {C}_{Q , M} + \frac{{W}_{MTOW} {C}_{T , M}}{\frac{1}{2} κ {p}_{0} {SM}_{0}^{2}}$$

$$M \dot{β} = - \frac{1}{{C}_{Q , \dot{β}}} ( {C}_{D , α} {M}^{2} βΔα + {C}_{D , β} {M}^{2} {β}^{2} + {C}_{D , M} {M}^{2} βΔ M + {C}_{D , p} Mp β + {C}_{D , r} Mr β + {C}_{Q , α} {M}^{2} Δα + {C}_{Q , β} {M}^{2} β + {M}_{0}^{2} {C}_{y , M} Δ M + 2 {M}_{0} {C}_{Q , M} Δ {M}^{2} + {C}_{Q , p} Mp + {C}_{Q , r} Mr + \frac{{m}_{0}}{\frac{1}{2} κ {p}_{0} δ} Δ {a}_{2}^{BFS} )$$

As these teachings show, a manufacturer of a fixed-wings AV can inexpensively generate an accurate APM of its aircraft. This APM may be employed for flight planning, simulation or design. Advantageously, the APM may continually be fine-tune and refine, should the payload or any other aspect of the AV geometry or mass configuration change.

These and other features, functions, and advantages that have been discussed can be achieved independently in various embodiments or may be combined in yet other embodiments.

1. A computer-implemented method for modeling performance of a fixed-wing aerial vehicle (AV) with six degrees of freedom, sequentially comprising the steps of:
collecting a first data set from a plurality of fuel consumption modelling measures and determining a fuel consumption model based on the first data set;
collecting a second data set from a plurality of thrust modelling maneuvers and determining a thrust model based on the second data set;
collecting a third data set from a plurality of aerodynamic forces modelling maneuvers and determining aerodynamic forces model based on the third data set;
collecting a fourth data set from a plurality of propulsive moments modelling maneuvers and inertia matrix modelling maneuvers and determining propulsive moments model and inertia matrix based on the fourth data set; and
collecting a fifth data set from a plurality of aerodynamics moments modelling maneuvers and determining aerodynamics moments model based on the fifth data set;
wherein modelling measures and modelling maneuvers are performed to modify an influence on the AV of one or more variables of a model to be determined.

2. The computer-implemented method of claim 1, further comprising a step of measuring variables of a model with a state estimator of the AV and air data system of the AV.

3. The computer-implemented method of claim 1, wherein determining a model further comprises applying a least square estimate to a collected data set.

4. The computer-implemented method of claim 1, further comprising a step of configuring a flight control system to automatically perform modelling maneuvers in flight.

5. The computer-implemented method of claim 1, wherein modelling maneuvers comprise at least one of the following control loops: AOS-on-rudder, altitude-on-bank speed-on-elevator, AOA-on-elevator, pitch rate-on-elevator and bank-on-ailerons.

6. The computer-implemented method of claim 1, wherein fuel consumption modelling measures are performed for a plurality of values of air density, outside air temperature (OAT) and throttle level.

7. The computer-implemented method of claim 1, wherein thrust modelling maneuvers are performed for a plurality of values of barometric altitude, mass variation and throttle level under a condition of coordinated flight.

8. The computer-implemented method of claim 7, wherein thrust modelling maneuvers comprise an altitude-on-bank control loop and a speed-on-elevator control loop.

9. The computer-implemented method of claim 1, wherein aerodynamic forces modelling maneuvers comprise AOA-on-elevator, AOS-on-rudder and speed-on-elevator control loops.

10. The computer-implemented method of claim 1, wherein propulsive moments modelling maneuvers comprise AOS-on-rudder and bank-on-ailerons control loops under a condition of coordinated flight.

11. The computer-implemented method of claim 1, wherein aerodynamic moments modelling maneuvers comprise AOS-on-rudder, bank-on-ailerons and q-on-elevator control loops.

12. A system for modeling performance of a fixed-wing aerial vehicle (AV) with six degrees of freedom, the system comprising:
a collecting unit configured to collect data from a plurality of modelling measures and modelling maneuvers;
a processing unit configured to communicate with a collecting unit, wherein the processing unit is further configured to sequentially process:
a first data set from a plurality of fuel consumption modelling measures and to determine a fuel consumption model based on the first data set;
a second data set from a plurality of thrust modelling maneuvers and to determine a thrust model based on the second data set;
a third data set from a plurality of aerodynamic forces modelling maneuvers and to determine aerodynamic forces model based on the third data set;
a fourth data set from a plurality of propulsive moments modelling maneuvers and inertia matrix modelling maneuvers and to determine propulsive moments model and inertia matrix based on the fourth data set;
a fifth data set from a plurality of aerodynamics moments modelling maneuvers and to determine aerodynamics moments model based on the fifth data set;
wherein modelling measures and modelling maneuvers are performed to modify an influence on the AV of one or more variables of a model to be determined.

13. The system of claim 12, wherein the collecting unit is further configured to instruct a state estimator and air data system to read out sensors values of the AV during modelling maneuvers.

14. The system of claim 12, wherein the processing unit is further configured to instruct a flight control system to automatically perform modelling maneuvers in flight.
